(19) United States
(12) Patent Application Publication
(10) Pub. No.: US 2024/0299780 A1
(43) Pub. Date: Sep. 12, 2024

(54) RESPIRATOR SYSTEMS FOR A CANINE

(71) Applicant: Applied Research Associates, Inc., Albuquerque, NM (US)

(72) Inventors: Geoffrey Alexander Kibble, Seguin, TX (US); Delbert Anthony Harnish, Panama City, FL (US); Courtney Sue Cooper Cumberland, Panama City Beach, FL (US); Sebastian MacNamara, Panama City Beach, FL (US); Christopher Scott Church, Panama City Beach, FL (US); Graham Wilson, Flint (GB); Simon Matthew Pougher, Neston (GB); William Nicholas Brown, Wrexham (GB)

(21) Appl. No.: 18/598,257

(22) Filed: Mar. 7, 2024

Related U.S. Application Data
(60) Provisional application No. 63/451,125, filed on Mar. 9, 2023.

(51) Int. Cl. A62B 18/06; A62B 7/10; A62B 7/12

(52) U.S. Cl. CPC A62B 18/06; A62B 7/10; A62B 7/12

(57) ABSTRACT

A canine respirator comprising a hood comprising: a viewing window, an air entry port for receiving fresh air; and an intake air manifold for distributing the fresh air into one or more channels, an air supply unit comprising: a controller, at least one filter for drawing in and filtering air from an environment, an air tube for delivering fresh air to the hood; and a mounting assembly, wherein the air supply unit is attached to a portion of a canine away from a body of the canine via the mounting assembly.

### RELATED APPLICATIONS

This application claims priority to earlier-filed U.S. Provisional Patent Application No. 63/451,125, entitled “RESPIRATOR SYSTEMS FOR A CANINE.” The above-referenced patent application is hereby incorporated by reference in its entirety into the present application.

### TECHNICAL FIELD

Embodiments of the present disclosure provide a respirator system for use with a canine to protect the canine from biological, chemical, radiological, nuclear, explosive, and/or other hazards.

### BACKGROUND

Gas masks and other personal protective equipment (“PPE”) have been adopted by military and civilian personnel since the proliferation of toxic chemical, biological, and other environmental biohazards. For canines, PPE that is a particulate filter is known, but such a filter that does not supply filtered, clean air to the canine does not provide protection from hazardous gases or other airborne substances. Accordingly, current systems and apparatuses that can be quickly donned to a canine do not provide extended protection against chemical, biological, radiological, nuclear, and/or explosive attacks.

### SUMMARY

The present disclosure relates to a canine respirator having a hood structurally and operatively configured for use with a canine. The hood includes a viewing window, an air intake port for receiving fresh air (e.g., filtered air or air from an external air source such as a breathing air supply line or an air tank), and an intake air manifold for distributing the fresh air into one or more channels. The canine respirator further includes an air supply unit including a controller, at least one filter for drawing in and filtering air from an environment, an air tube for delivering fresh air to the hood, and a mounting assembly, wherein the air supply unit is attached to a portion of the canine away from a body of the canine via the mounting assembly.

In some aspects, the techniques described herein relate to a canine respirator including a hood. The hood includes a viewing window, an air intake port for receiving fresh air, an intake air manifold for distributing the fresh air into one or more channels, and at least one hood fastener for an air supply unit. The air supply unit includes a controller, a first filter for drawing in and filtering air from an environment, an air tube for delivering fresh air to the hood, and a mounting assembly. The air supply unit is attached to a portion of a canine away from a body of the canine via the mounting assembly. The canine respirator also includes a harness for placement around the body of the canine, wherein the harness includes at least one harness fastener. The at least one hood fastener connects to the at least one harness fastener for connecting the hood to the harness, wherein connecting of the hood to the harness prevents the canine from removing the air supply unit.

In some aspects, the techniques described herein relate to a method of providing fresh air to a canine, the method including steps of providing a canine respirator for use with a canine; placing the hood on a head of a canine; mounting an air supply unit on the canine at a position away from a body of the canine; securing a harness on the body of the canine; connecting the hood to the harness; causing the air supply unit to draw in and filter air from an environment; and causing the air supply unit to deliver air from the air supply unit to the hood. Connecting the hood to the harness prevents the canine from removing the air supply unit.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1A depicts one example of a perspective view of a canine respirator;

FIG. 1B depicts one example of a perspective view of a canine respirator;

FIG. 1C depicts the respective components of the canine respirator of FIG. 1A;

FIG. 1D depicts the respective components of the canine respirator of FIG. 1B;

FIG. 1E depicts one example of a canine on which a canine respirator may be used;

FIG. 2A depicts one example of a front perspective view of a hood placed on a canine according to some embodiments;

FIG. 2B depicts one example a front perspective view of the interior of a hood according to some embodiments;

FIG. 2C depicts one example a is a side perspective view of an internal harness placed on a canine according to some embodiments;

FIG. 3 depicts one example a side perspective view of a harness placed on a canine according to some embodiments;

FIG. 4A depicts one example a front perspective view of a powered air purifying respirator system according to some embodiments;

FIG. 4B depicts a front perspective view of an exemplary powered air purifying respirator system according to some embodiments;

FIG. 5 depicts one example of a system architecture of a control system according to some embodiments;

FIG. 6 depicts one example a perspective view of a canine respirator placed on a canine depicting the flow of air according to some embodiments; and

FIG. 7 depicts a hardware platform for some embodiments.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description of embodiments of the present disclosure references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized, and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the present technology can include a variety of combinations and/or integrations of the embodiments described herein.

Numerous problems exist in presently employed respirators and other PPE for canines. Canines are often deployed in risk-associated environments, such as forest fires, military operations, and search and rescue operations. In these scenarios, canines may be exposed to hazardous or harmful particulates or other hazardous environments or materials. During such environmental risks and when PPE for the canine is used, canines are particularly susceptible to hypercapnia or hypoventilation due to carbon dioxide exhalation. The presence of dead spots or lack of circulation in a PPE, such as a mask or respirator, can lead to potentially fatal health risks for the canine. This problem is particularly problematic because canines also have a rapid breathing rate (e.g., 10 to 30 breaths per minute/200 pants per minute) and require significant oxygen to be supplied in a respirator. With this rapid breathing rate, canines correspondingly expel a considerable amount of carbon dioxide (CO₂). When a mask, hood, or other PPE is placed on the head of the canine, the adequate expulsion of CO₂ presents a significant and potentially fatal obstacle that must be addressed when designing PPE for a canine. For example, the considerable oxygen demands of the canine must be balanced and accounted for when also considering the buildup of CO₂.

Additionally, when designing a respirator for delivering fresh air to meet the oxygen demands of a canine, the weight and placement of the respirator and accompanying equipment must also be considered. For example, the anatomical layout of a canine provides certain considerations regarding weight distribution and placement. The neck of the canine is of particular concern, as excessive weight applied to the neck region may cause stress and damage to the canine. Additionally, the back or spine of the canine is similarly an area that may be prone to stress and damage if an applied weight is too great. For example, certain breeds of service canines may be bred for agility or speed traits at the cost of a weaker back.

In addition to health concerns of the canine, practical limitations of placement and use of respirators are also a problem. For example, the quadrupedal nature of a canine provides additional considerations in the design of a canine respirator. Currently implemented canine respirators that are positioned and secured to the back of the canine can lead to performance and/or movement issues of a canine. For example, in service, military, rescue, or other operations, a canine may be required to sprint, jump, or move with a degree of agility. A weight applied to the back of the canine, such as respirator equipment, can cause a hindrance to the movement of the canine. For example, a weight applied to the back of the canine can cause a potential weight imbalance as the canine is moving. With the quadrupedal movement of the canine, significant lateral movement occurs even during a straight-line movement of the canine. A weight applied to the back of the canine can cause significant swaying, leading the canine to lean in a lateral direction, requiring additional energy by the canine for course correction. During a tactical operation or other service scenario, any wasted energy of the canine can lead to significant risks or complications, potentially jeopardizing the operation.

Additionally, the positioning of a respirator or parts of the respirator on the back of the canine can lead to challenges during the use of the respirator. For example, respirator equipment for the canine is connected to a hood, mask, or breathing apparatus through a tube. When respirator equipment is placed on the back, the tube must traverse across a length of the body, providing increased surface area for the tube to snag against objects and leading to an increased risk of the tube becoming disconnected or damaged. Additionally, securing respirator equipment to the back of the canine limits potential storage areas. For example, in rescue and/or military operations, a canine may be paired with storage bags for storing equipment, medicine, tools, among other items. By positioning respirator equipment on the body of the canine, potential storage locations on the canine are reduced.

The present disclosure provides solutions to the identified problems among other advantages and improvements in the field of respirators for canines. First, to aid in reducing and/or limiting the presence of dead pockets or spaces of air in a breathing mask, the present disclosure includes a hood having an intake air manifold for distributing fresh air. The intake air manifold may be located near the snout of the canine, providing air directly to the airways of the canine. The intake air manifold may also include one or more outlets to provide air to the hood . . . . Additionally, the distributing of the air may also aid in the circulation of the air within the hood, preventing any pockets of CO₂.

Second, to aid in reducing strain or forces applied to the neck and/or back of the canine, the respirator equipment may be secured away from the body of the canine. For example, the respirator equipment may be located on a collar, which may be secured around the neck or head of the canine. To aid in preventing strain, after securing, the collar and respirator equipment may rest against the chest region of the canine. Accordingly, while not secured or attached to the body of the canine, the present disclosure may nonetheless utilize portions of the body to alleviate the weight of the respirator equipment from the neck.

The above-discussed solutions are not an exhaustive list of solutions and advantages of the identified problem. Additional solutions and advantages are provided herein.

### Canine Respirator and Canine

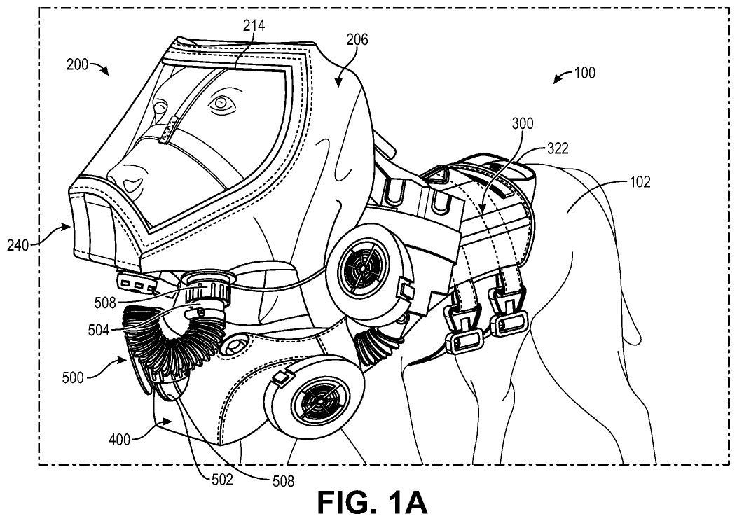

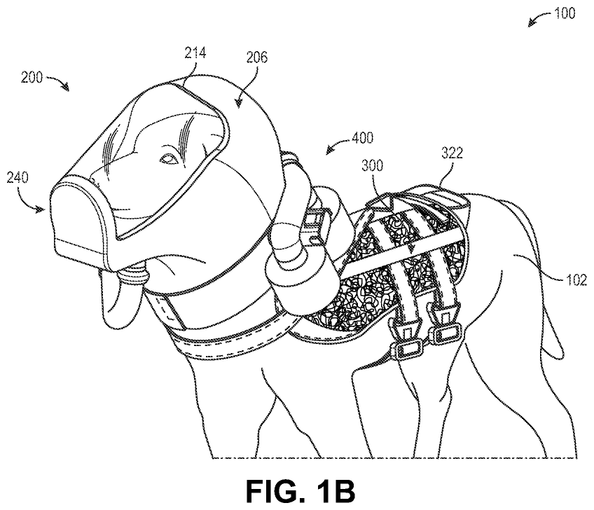

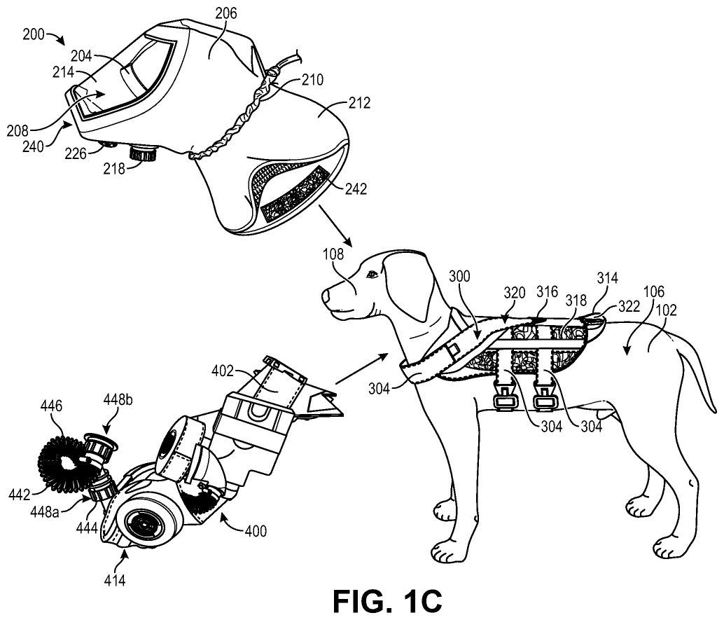

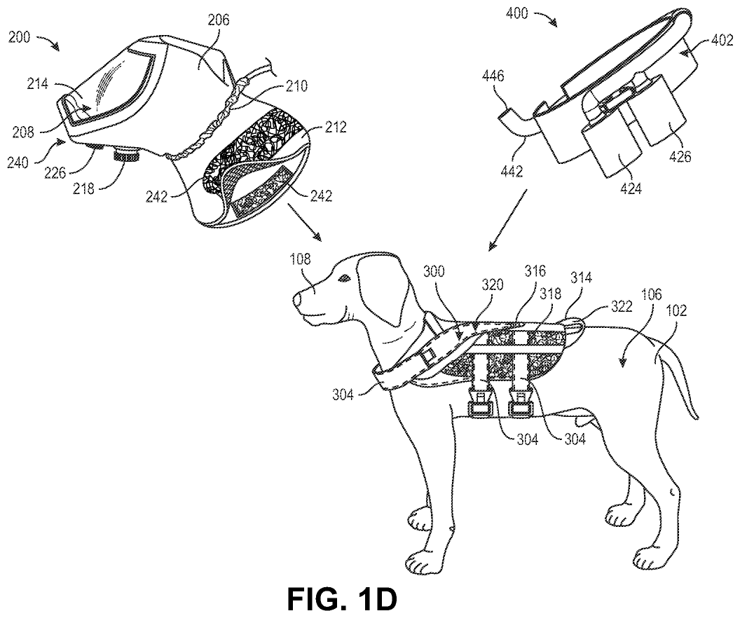

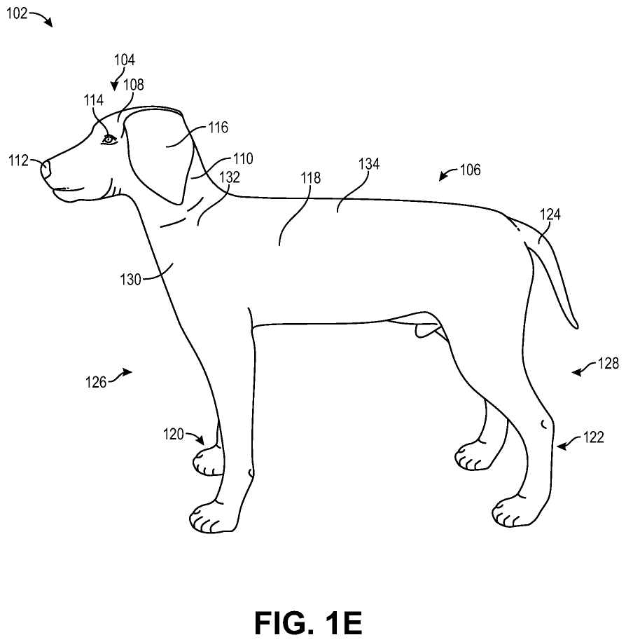

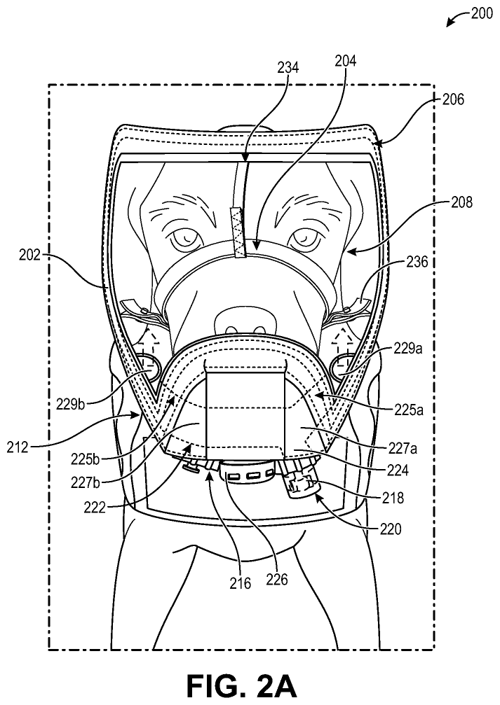

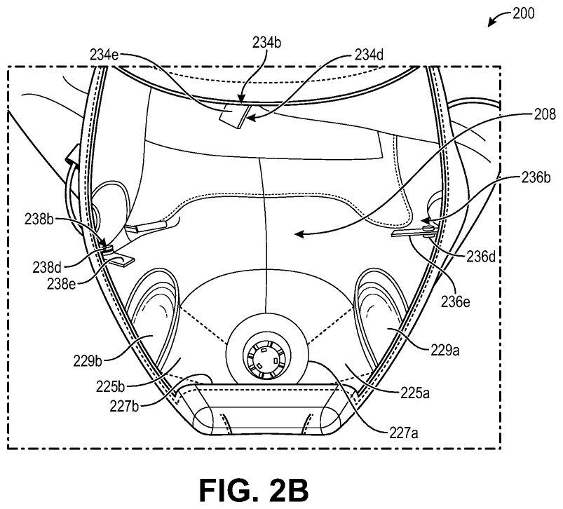

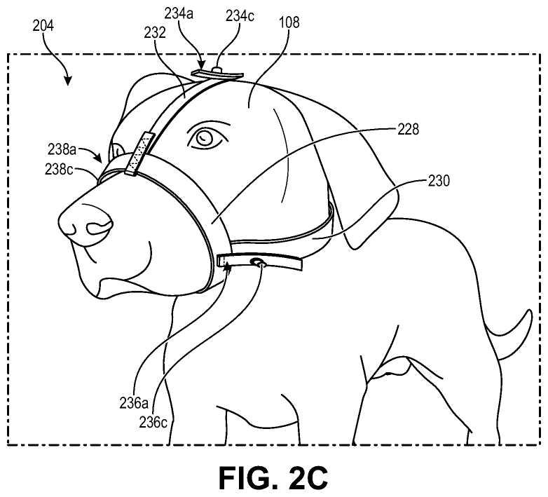

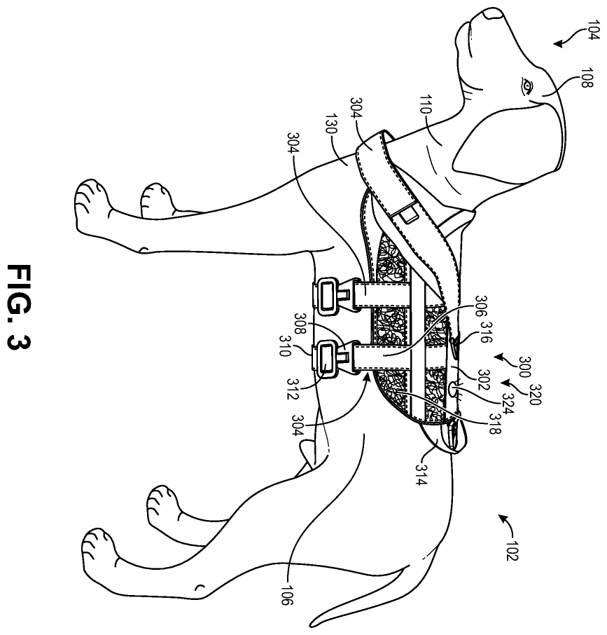

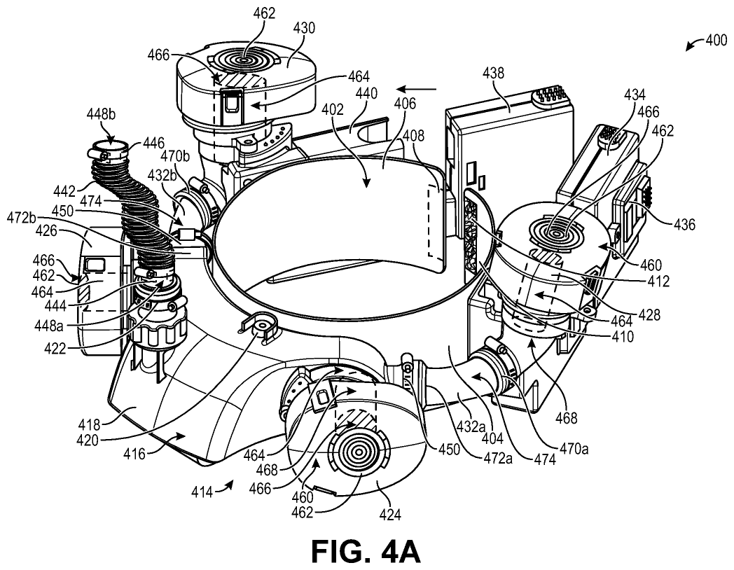

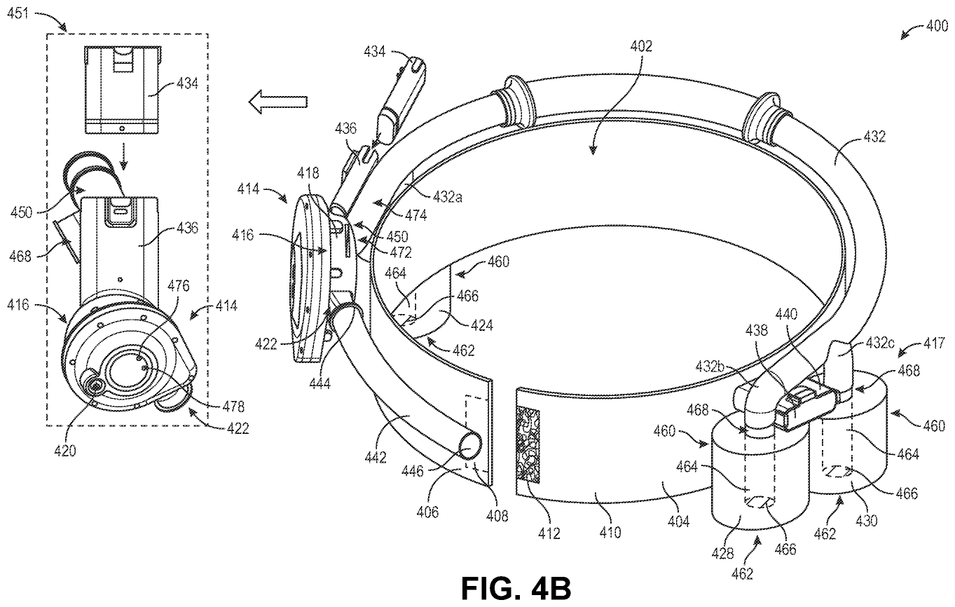

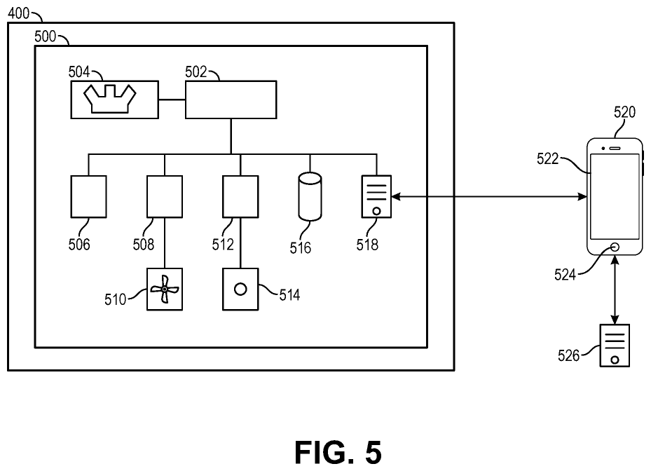

FIGS. 1A and 1B depict exemplary embodiments of a respirator system for a canine or more generally a canine respirator 100 placed on a canine 102. Once donned, the canine respirator 100 provides protection and/or breathable air for a canine 102 exposed to environmental risks. Embodiments of the canine respirator 100 include a hood 200 (described with reference to FIGS. 2A-2C), a body harness 300 (described with reference to FIG. 3), an air supply unit 400 (described with reference to FIGS. 4A-4B), and a control system 500 (described with reference to FIG. 5). After donning and powering on, the canine respirator 100 draws in air from the environment, filters the air via the air supply unit 400, and transports the purified air to the hood 200 for circulation and use by the canine 102 and for discharge of the consumed air.

As illustrated in FIGS. 1C-1D, the various components of the canine respirator 100 may be attached to various positions on the canine 102. The positioning of the various components of the canine respirator 100 may be adapted for a canine's anatomy and physical requirements. For example, the body harness 300 may be attached and secured to the body 106 of the canine 102; the hood 200 may be placed on the head 108 of the canine 102; and the air supply unit may be mounted to the neck 110 of the canine 102.

FIG. 1E depicts an exemplary canine 102 to which the canine respirator 100 may be donned. The canine 102 may be any breed and/or species in the canis genus, including service and/or civilian canines. By way of non-limiting example, canine 102 may be a German Shepherd, Belgian Malinois, Doberman Pinscher, St. Bernard, Labrador Retriever, or any other breed of canine. The anatomy of the canine 102 includes a head region 104 and a body 106. As discussed herein, an anterior-most position of the canine is a distal end of the canine's snout, i.e., the end of the canine's snout.

The head region 104 includes the head 108 and neck 110 of the canine 102. The head 108 includes at least the snout 112, the eyes 114, and the ears 116 of the canine. Additionally, the neck 110 connects the head 108 to the body 106 of the canine 102. In some embodiments, one or more components of canine respirator 100 may be placed or secured approximate to the head region 104. For example, hood 200 is placed around the head 108, providing protection and a pocket of circulated air to the canine 102. Additionally, air supply unit 400 may be placed and secured approximate to the neck 110.

The body 106 of the canine 102 includes a torso 118, forequarters 120, hindquarters 122, and a tail 124. The torso 118 includes an anterior side 126 and a posterior side 128. As depicted, forequarters 120 correspond to the anterior side 126, and the hindquarters 122 correspond to the posterior side 128. The anterior side 126 includes the chest 130 and withers 132 of the canine 102.

As described in detail below, components of canine respirator 100 may be attached and secured away from the body 106 of the canine 102, i.e., the neck 110 of the canine 102. However, while the canine respirator 100 may be secured away from the body 106, the body 106 of the canine 102 may nonetheless aid in supporting the weight of the canine respirator 100, providing relief and support to the neck 110. For example, components of canine respirator 100 may be secured around the neck 110 of the canine 102, but after securing, may rest against the anterior side 126 such as against the chest 130 and/or the withers 132. Through this resting, the anterior side 126 may support at least a portion of the weight of the canine respirator 100.

### Hood of the Canine Respirator

As depicted by FIGS. 2A-2C, the canine respirator 100 includes a hood 200 for placement around at least the head 108 of the canine 102. The hood 200 comprises a head enclosure 206, a sealing assembly 210 for sealing the hood body to the canine, an air intake and distribution system 216 for introducing fresh air (e.g., filtered air or air provided by an external air source such as a breathing air supply line or an air cylinder) into the head enclosure 206, and an internal optional head harness 204 for connecting the hood 200 to the canine 102. As described in greater detail below, each aspect/component of the hood 200 may comprise various sub-parts and/or sub-components. When assembled and donned, the hood 200 provides a dual benefit of protecting the eyes 114, snout 112, and ears 116, of the canine 102 from harmful particulates, particles, droplets, and/or vapor in the air and provides an enclosure for the introduction of fresh air for consumption by the canine 102.

As described above, the hood 200 comprises a head enclosure 206 for covering at least the head 108 of the canine 102 and providing protection and an enclosure for holding fresh air for the canine 102 to consume. As shown in FIGS. 1C-1D, the head enclosure 206 comprises a skirt 212 extending from the head enclosure 206 and at least partially covering the neck 110 of the canine 102, a breathable zone 208 providing a pocket or void space for the introduction and circulation of fresh air, and a viewing window 214 incorporated into the head enclosure 206 to allow the canine 102 to see.

The head enclosure 206 is adapted and configured as a mask, helmet, or other encapsulation covering acting as a barrier to protect the head 108 from the environment. Accordingly, the overall shape of the head enclosure 206 generally matches the anatomy of the head 108 of the canine 102, comprising a generally oval, egg-shaped, or elongated design. The overall dimensions of the head enclosure 206 may vary, depending on the breed and/or size of the canine 102. However, the size of the head enclosure 206 should be larger than the head 108 of the canine 102, such that there is a spacing or gap between the head 108 of the canine 102 and the material of the head enclosure 206, i.e., the breathable zone 208. By way of non-limiting example, the head enclosure 206 may be sized so that there is a spacing of approximately 1 inch to approximately 5 inches between the head 108 and the head enclosure 206.

The breathable zone 208 provides the void space or pocket for the introduction of fresh air into the head enclosure 206. The breathable zone 208 corresponds to the location in the head enclosure 206 that is approximate to the snout 112 of the canine 102, such that fresh air that enters and fills the breathable zone 208 is available for inhalation and consumption by the canine 102. Because of the fluid and container filling nature of oxygen and other gases, the breathable zone 208 may comprise the entirety of the interior of the head enclosure 206 starting at a distal end 240 and terminating at the location of the sealing assembly 210. However, in further embodiments, the dimensions of breathable zone 208 may be reduced by other parts or components of the hood 200, i.e., the air intake and distribution system 216.

As fresh air is introduced from the air supply unit 400, the fresh air may enter and fill the breathable zone 208, providing air for the canine to consume 102. As described above, the dimensions of the head enclosure 206 may vary depending on the breed of canine the hood 200 will be used with, and accordingly, the dimensions of the breathable zone 208 may also vary and scale, providing for varying volumes of fresh air that may be introduced into the breathable zone 208.

As illustrated in FIGS. 1C, 1D, and 2A, the head enclosure 206 further includes a skirt 212 comprising a segment of material extending past the canine's head 108 when the hood 200 is donned on the canine 102. The skirt 212 provides additional protection to the canine 102, thereby reducing the surface area of the canine 102 that may require decontamination upon escape from the affected area and further providing protection from harmful elements. In embodiments, and as described in greater detail below, the skirt 212 is removably couplable with the body harness 300 located on the body 106 of the canine 102, such that the skirt 212 provides a structure for securing the hood 200 to the body harness 300, as discussed below.

The skirt 212 extends from the head enclosure 206 and past the sealing assembly 210 (described below), such that the skirt 212 extends along the length of the neck 110 of the canine 102 when the respirator 100 is donned by the canine 102. In other embodiments, the skirt 212 may be adapted and configured to extend and reach the body 106 of the canine 102. In embodiments, the skirt 212 may be adapted to cover some or all of the canine's body 106. Thus, a length of the skirt 212 may be dimensioned to extend along the canine's neck 110, along the neck 110 and at least a portion of the canine's body 106, or along the neck 110 and a general majority of the canine's body 106.

As described in greater detail below, the skirt 212 may couple or otherwise attach to the canine body sleeve 302 of the harness 300, thereby connecting and securing the hood 200 to the harness 300. Additionally, or alternatively, the skirt 212 may couple or otherwise attach to air supply unit 400, thereby connecting and securing the air supply unit 400 to hood 200, as described below. To accomplish at least one of the prior mentioned couplings, skirt 212 may comprise one or more skirt fasteners 242. The skirt fasteners 242 may be any known mechanical fasteners, including hook and loop fasteners, such as VELCRO®, buckles, belts, straps, buttons, magnets, or other fasteners. As shown in FIGS. 1C and 1D, one or more skirt fasteners 242 is hook and loop, such as VELCRO®, selectively located at pre-selected positions on an interior and/or an exterior of the skirt 212. The interior of skirt 212 is depicted in FIGS. 1C and 1D by the broken lines, depicting the skirt fastener 242 at an interior position within the dimensions of skirt 212.

To contour to the shape of the canine 102 and to allow the canine 102 to walk, run, and perform other actions, portions of the hood 200 may be constructed from a flexible material, including for example, the head enclosure 206 and the skirt 212. The flexible material of the head enclosure 206 may also aid a human operator in placing and securing the head enclosure 206 to the canine 102. To protect the canine 102 from environmental risks, the material used in constructing or manufacturing the head enclosure 206 may be a resistant material rated to protect the canine from chemical agents, biological risks, toxic materials, or other harmful materials. For example, embodiments of head enclosure 206 may be constructed from NFPA 1994 Class-2 ensemble material or other suitable resistant materials, including any currently known material or any yet to be discovered materials. Particularly, as advances are made with respect to resistant material, the material used to construct the head enclosure 206 may be selected based on desired usage, resistant ratings, among other factors.

To aid the canine 102 in seeing, the head enclosure 206 may include at least one viewing window 214, as depicted in FIG. 2B. The viewing window 214 may be a transparent or see-through portion of the head enclosure 206 disposed at a front-facing side of the hood body 202. The viewing window 214 may be located approximate to at least one eye 114 of the canine 102 when the head enclosure 206 is donned. For example, in some embodiments, the viewing window 214 may be designed as a singular visor, providing a single viewing window for both eyes 114. In further embodiments, the viewing window 214 may be designed having two or more viewing windows, corresponding to the general location of each eye 114.

To provide both protection to the canine and to allow the canine 102 to see, the viewing window 214 may be constructed from a sheet of 2D polycarbonate or other similar material. For example, the material used to construct the viewing window 214 may be any transparent and resistant material. Accordingly, with the viewing window 214, a canine 102 may be both protected from environmental risks while retaining sight to escape from the environmental risk.

In some embodiments, the viewing window 214 may be permanently coupled to the hood body 202. For example, the viewing window 214 may be molded into the hood body 202, may be fastened using an adhesive, among other attachment methods. However, to prevent the release of fresh air from the hood 200 or to prevent the entry of contaminated air, embodiments of the viewing window 214 may be coupled or attached to head enclosure 206 using an air-tight fastening method.

### Sealing Assembly

As noted above, the hood 200 further comprises a sealing assembly 210 (see FIGS. 1C and 1D). The sealing assembly 210 of the hood 200 aids in keeping fresh air inside the head enclosure 206 and contaminated air from entering the head enclosure 206. The sealing assembly 210 may be a strap, cord, or other apparatus that tightens or cinches at least a portion of hood 200 against the fur and/or skin of the canine 102.

For example, in some embodiments, the sealing assembly 210 may include a plurality of loops and a band of elastic material. Continuing with this example, a plurality of loops may be circumferentially positioned around a boundary of the head enclosure 206 and an elastic band, such as a paracord or other similar elastic material may be disposed within the external loops. The loops and paracord may extend up to the entire circumference of the head enclosure 206, providing the operator greater ease in donning on the head enclosure 206 and for providing a greater sealing effect. In some embodiments, the sealing assembly 210 may be disposed on the exterior surface of the hood body 202. In further embodiments, the sealing assembly 210 may be disposed on the interior surface of the hood body 202. In even further embodiments, the head enclosure 206 may be constructed from two or more layers of material, with the sealing assembly 210 disposed between two layers of material.

The location of the sealing assembly 210 may vary but generally is disposed behind the head 108 of the canine 102. For example, in some embodiments, the sealing assembly 210 is located approximately where the head 108 and neck 110 of the canine are joined. In further embodiments, the sealing assembly 210 is located at a position on the neck 110 of the canine 102. In even further embodiments, the sealing assembly 210 is located at a position on the body 106 of the canine 102.

The sealing assembly 210 may be configured with different designs depending on the embodiments and, for example, may be an adjustable strap. In operation, the adjustable strap may initially have a length providing for a loose fit of the head enclosure 206. After sliding or placing the head enclosure 206 over the head 108 of the canine 102, the adjustable strap may be tightened, thereby cinching the head enclosure 206 to the skin of the canine 102. However, the sealing assembly 210 may include any suitable design for providing a sealing effect.

Through the elastic design or otherwise cinching effect of the sealing assembly 210, an operator may quickly respond to an environmental risk and place hood body on the canine 102. For example, an operator may stretch the elastic band to increase the size of at least a portion of the head enclosure 206 to don over the head 108 of the canine 102. After sliding or placing the hood body 202, the operator may relax the tension on the elastic band, causing the sealing assembly 210 to cinch to the skin of the canine 102. Accordingly, fresh air may be trapped or otherwise retained in the breathable zone 208 of the head enclosure 206. The elastic nature of the sealing assembly 210 therefore provides the benefit of keeping fresh air trapped in the breathable zone 208, prevents the inadvertent release of fresh air, and aids the operator in quickly donning the head enclosure 206 on the canine 102. In further embodiments, the sealing assembly 210 does not provide a hermetic seal, allowing an amount of fresh air to egress from the breathable zone. The egress of some fresh air aids in preventing the ingress of contaminants or environmental particulates from entering the breathable zone 208.

### Air Intake and Distribution System

To ensure that only fresh air is introduced into the breathable zone 208 of the head enclosure 206, hood 200 further comprises an air intake and distribution system 216 (see FIG. 2A). The air intake and distribution system 216 comprises an air entry port 218, an intake air manifold 222, and a consumed air outlet 226. As described herein, the air intake and distribution system 216 receives fresh air (e.g., filtered air or air supplied from an external supply source) from the air supply unit 400, transfers the air to the breathable zone 208, circulates the fresh air in the breathable zone 208, and expels consumed air, among other functions.

As illustrated in FIGS. 2A-2B, portions of the air intake and distribution system 216 may be disposed at a bottom of the head enclosure 206 approximate to the distal end 240 of the head enclosure 206, i.e., approximate to the anterior-most position of the canine 102 when the respirator 100 is donned by the canine 102. Portions of air intake and distribution system 216 are depicted in FIG. 2A with dashed lines to delineate the internal position of the air intake and distribution system 216 as located in the interior of head enclosure 206. At such a location, the air intake and distribution system 216 may generally be located approximate to the snout 112 of the canine 102. Embodiments of canine respirator 100 may benefit from positioning air intake and distribution system 216 at the distal end of the head enclosure 206 to provide fresh air directly to the snout 112 of the canine 102 and for preventing or limiting pockets of dead air or CO₂. In some embodiments and as described below, fresh air is provided along fluid channels to opposing sides of the canine's snout proximate the canine's two nostrils.

The air entry port 218 is a port or inlet disposed on the hood 200 for receiving fresh air from the air supply unit 400. Accordingly, the air entry port 218 may be a butyl rubber-gasketed passthrough or any other suitable inlet. As described below, the air entry port 218 of the air intake and distribution system 216 may be adapted and configured to couple with tubing or other channel-forming structure for transferring fresh air from air supply unit 400 into the breathable zone 208 of the interior of the hood 200. Accordingly, the air entry port 218 is further configured for selective and removable coupling to a tube or transport hose. The location of the air entry port 218 may vary, but in embodiments, is located at the distal end 240 of the hood 200. Positioning the air entry port 218 at the distal end 240 thereby introduces fresh air approximate to the snout 112 of the canine 102.

To aid in protecting the canine 102 from an environmental risk, the air entry port 218 may also include a self-sealing assembly 220 shown within air entry port 218. The self-sealing assembly 220 may be adapted and configured to automatically seal when the air tube 442 is disconnected from the air entry port 218. The self-sealing assembly 220 may include a valve, such as a check valve, configured to automatically seal upon disconnection of the air tube 442 from the air entry port 218. The self-sealing assembly 220 may accordingly provide protection to the hood 200 when the tubing is disconnected from the hood 200. Through such protection, the interior of hood 200 is protected from the introduction of contaminants and/or environmental particulates.

To aid in delivering fresh air to the canine 102 in a safe and efficient manner, the air entry port 218 is fluidly coupled to the intake air manifold 222, as depicted in the phantom lines of FIG. 2A. In embodiments, at least a portion of the intake air manifold 222 is positioned within an interior of the head enclosure 206 of hood body 202. To aid in delivering fresh air to each side of the canine's snout 112, the intake air manifold 222 may include an intake inlet 224 fluidly coupled to the air entry port 218, providing a pathway for the received fresh air. The intake air manifold 222 further comprises a first channel 225a and a second channel 225b each fluidly connected to the intake inlet 224. The first channel 225a comprises a first end 227a that is fluidly connected to the intake inlet 224. Additionally, the second channel 225b also comprises a first end 227b that is fluidly connected to the intake inlet 224.

Each channel includes an open second end, such that the first channel 225a includes open second end 229a, and the second channel 225b includes open second end 229b. The open second ends 229a, 229b provide an outlet for fresh air fluidly communicated through the air entry port 218 and channels 225a, 225b to exit to the breathable zone 208 of the head enclosure 206, such that when the respirator 100 is donned by the canine 102, the canine's snout 112 is positioned proximate the open second ends 229a, 229b for inhalation of the fresh air. As such, fresh air is provided directly to the canine's nostrils. Accordingly, at least two channels 225a, 225b may be provided in embodiments to accommodate the canine's snout 112 configuration having nostrils on opposing sides of the snout 112. As shown in FIGS. 2A-2B, each channel presents a fluid pathway for the transport of fresh air from the intake air manifold 222, through the intake inlet 224 and channels 225a, 225b, and exiting the respective open second ends 229a, 229b positioned proximate the canine's snout 112 when the respirator 100 is donned. Each exit from the open second ends 229a, 229b and into the breathable zone 208 is depicted by a dotted arrow in FIGS. 2A-2B for the delivery fresh air to each side of the snout 112 and/or for aiding in circulating the fresh air inside hood 200.

Through the two-channel configuration comprising two openings, fresh air is introduced to the breathable zone 208 from two different locations. Through such bi-locational introduction, two separate airflows following distinct fluid pathways are created within the breathable zone 208. The two air pathways are particularly beneficial in introducing fresh air to different locations within the volumetric dimensions of the breathable zone 208 and head enclosure 206, thereby reducing or eliminating potential pockets of stagnant air or carbon dioxide buildup. As canines are susceptible to carbon dioxide poisoning, the reduction of carbon dioxide pockets is particularly important. Additionally, the two channels 225a, 225b are provided generally opposite each other on lateral sides of the head enclosure and at an anterior position of the head enclosure (i.e., anterior to the head of the canine).

In some embodiments, first channel 225a and second channel 225b may at least partially overlap, such that a joined or combined channel is formed by first channel 225a and second channel 225b. For example, the intake air manifold 222 may comprise a T-shaped or Y-shaped configuration, with a portion of the first channel 225a and a portion of second channel 225b split from at a junction from a common pathway. In further embodiments, the overlap of first channel 225a and second channel 225b may be so great as to provide no clear delineation between first channel 225a and second channel 225b. For example, first channel 225a and second channel 225b be completely combined, such that intake air manifold 222 comprises a single channel, pathway, or void space, defined by the intake inlet 224 that is fluidly coupled to the fresh air manifold 222 and intake outlets.

The head enclosure 206 may further include at least one consumed air outlet 226. In some embodiments, the consumed air outlet 226 may be disposed approximate to the distal end 240 of the head enclosure 206 near the location of the snout 112 and adjacent or near the air entry port 218. The air outlet 226 may be a defined channel, outlet, or passage for the expelling of air from the breathable zone 208 of the head enclosure. For example, following consumption of a portion of the fresh air, the canine 102 may exhale, and the exhaled air may be directed out of the hood 200 via air outlet 226. To prevent the inadvertent entry of contaminated air from the environment, the consumed air outlet 226 may include filters and/or gaskets to prevent the introduction of air from the environment while simultaneously providing for the expulsion of consumed air in response to the exhalation of the canine 102. Additionally, or alternatively, skirt 212 may be configured to expel air from the breathable zone 208 and direct exhaled air out of hood 200. For example, a portion of the exhaled air may be directed out of the hood 200 via air outlet 226 and a portion of the exhaled air may be directed out of the hood 200 via the skirt 212. Embodiments are contemplated in which head enclosure 206 does not include air outlet 226 and skirt 212 facilitates air circulation in hood 200. For example, the exhaled air may be directed through a space between the canine 102 and the skirt 212 to facilitate the circulation of air in hood 200.

### Internal Head Harness of Hood

To aid in donning the hood to the canine 102 and/or to aid in keeping an alignment of the hood 200 once donned, the hood 200 may further include an optional internal head harness 204 (see FIG. 2C). The head harness 204 is designated as optional, as Applicant has found that the canine respirator 100 described herein can be effectively used without the head harness 204. As should be appreciated, attachment or fastening means as described herein between the head harness 204 and other portions of the canine respirator will not be required if the head harness is not utilized.

The internal head harness 204 may be a head harness attachment for affixing to the head 108 of the canine 102. Accordingly, the internal head harness may comprise a plurality of straps, lengths of material, or other head apparel for affixing to the head 108 of the canine and at least one fastener for coupling the internal head harness to the head enclosure. In embodiments, the internal head harness 204 may include a snout strap 228, a head strap 230, and a vertical bridging strap 232, providing for a secure fit for securing the internal head harness 204 to the head 108 of the canine 102.

As depicted, the snout strap 228 may be a piece of material having a preselected length that may loop around the snout 112 of the canine 102. The design of the snout strap 228 may be particularly advantageous for sliding the snout strap 228 over the nose and mouth of the canine 102. The snout strap 228 may continue to be slid over the snout 112 of the canine 102 until reaching a predetermined location. For example, the snout strap 228 may rest just below the eyes 114 of the canine 102. The snout strap 228 may be retained in place through an interference fit between the snout strap 228 and the snout 112.

In some embodiments, snout strap 228 may have a fixed or non-adjustable length. For example, through the tapered design of the snout 112, snout strap 228 may slide over top of the snout until reaching the point where the snout 112 has a larger size than the size of the snout strap 228, thereby creating an interference fit. In further embodiments, snout strap 228 may be adjustable to tighten the fit against the snout 112. For example, after reaching a predetermined location on the snout 112, an operator may adjust and tighten snout strap 228 to the snout 112.

The head strap 230 of the internal head harness 204 may be another piece or strap of material coupled to the snout strap 228 and for wrapping around the head 108 of the canine 102, providing additional security. The head strap 230 may couple to the snout strap 228 at two positions. For example, the head strap 230 may couple to the snout strap 228 at positions approximate to each lateral side of the snout 112 of the canine 102. The head strap 230 may extend from the snout strap 228 and wrap around the back of the head 108 of the canine 102, thereby securing the internal head harness 204 to the head 108.

The head strap 230 may include a single strap or piece of material used to secure the head strap 230, and by extension the internal head harness 204, to the head 108 of the canine 102. For example, in some embodiments, the head strap 230 may be a single strap of paracord or another elastic material. Accordingly, an operator may stretch out the head strap 230 to wrap around the head 108 of the canine 102 and release the head strap 230 to secure the head strap 230 to the head 108. In further embodiments, the head strap 230 may include an adjustable member, such as a buckle, to adjust the length of the head strap 230. In further embodiments, the head strap 230 may include two or more straps or pieces of material that may be joined together to tighten and secure the head strap 230, and by extension the internal head harness 204 to the head 108. For example, the head strap 230 may include two straps, with one strap coupled to the snout strap 228 at a first position and a second strap coupled to the snout strap 228 at a second position. For coupling purposes, each of the two individual straps may include a fastener for adjoining the straps together. For example, in some embodiments, each of the individual straps may include compatible fasteners, such as a male buckle and a female buckle, or corresponding fasteners of a quick release fastening system, such as corresponding members of a COBRAR fastening system. However, any fastening method may be implemented to secure the head strap 230.

As further depicted, internal head harness 204 may include a vertical bridging strap 232 coupled to snout strap 228 and head strap 230. In some embodiments, vertical bridging strap 232 may be a bridging strap or piece of fabric disposed at a center position at the head 108 of the canine 102. For example, in embodiments, vertical bridging strap 232 may couple to snout strap 228 approximately at the bridge of the nose of the canine 102. Vertical bridging strap 232 may provide an additional coupling point between snout strap 228 and head strap 230, aiding in maintaining the position of internal head harness 204 on the head 108 of the canine 102. As described in greater detail below, vertical bridging strap 232 may provide a location for the placement of a fastener, which may aid in coupling the internal head harness 204 to the hood body 202.

In some embodiments, each of the snout strap 228, the head strap 230, and the vertical bridging strap 232 may be constructed from a flexible material, such as nylon, webbing, or other flexible material to contour to the shape of the head 108.

The head enclosure 206 and internal head harness 204 includes a plurality of fastening assemblies 234, 236, 238 that, in embodiments of the present disclosure, enable removably coupling of the hood 200 to the internal head harness 204 and operator donning of the hood 200 to the canine 102. The plurality of fastening assemblies 234, 236, 238 for the hood 200 and internal head harness 204 provides for the advantage that as the canine moves it heads laterally, i.e., left-right, or vertically, i.e., up-down, the hood 200 follows the movement of the canine's head, such that the viewing window remains generally aligned with the eyes of the canine. That is, as the canine's head moves laterally left-right, for example, the hood 200 also commensurately moves laterally left-right with the movement of the canine's head. Similarly, as the canine's head moves vertically up-down, the hood 200 also commensurately moves vertically up-down with the movement of the canine's head. Because the internal head harness 204 (when utilized with the respirator 100) is removably coupled with the hood 200 via the plurality of fastening assemblies 234, 236, 238 at various positions relative to the canine's head, movement of the canine's head correspondingly moves the hood, allowing for the canine to see through the full range of the viewing window. Such a configuration should be compared to not including the internal head harness with a plurality of fastening assemblies at various locations on the canine's head, such that the canine's head moves within the hood, but the hood does not correspondingly move with the canine's head.

In embodiments where the head harness 204 is not utilized, hood 200 may move with the canine's head sufficiently without the use of internal head harness 204. As stated above, in such embodiments that forgo use of the head harness 205, hood 200 does not comprise the plurality of fastening assemblies 234, 236, 238.

Referring to FIGS. 2B-2C, the plurality of fastening assemblies 234, 236, 238 of the hood 200 and internal head harness 204 will now be described. To assist in donning the hood 200 and enabling the movement of the canine's head within the hood as described above, each fastening assembly 234, 236, 238 comprises a head harness fastener 234a, 236a, 238a and a mating respective hood fastener 234b, 236b, 238b. The plurality of fastening assemblies includes a first fastening assembly 234 positioned at a general top of the canine's head once the hood 200 is donned, a second fastening assembly 236 positioned at a general left lateral side along the jaw and/or side of the canine's head once the hood is donned, and a third fastening assembly 238 positioned opposite the second fastening assembly 236 and at a general right lateral side along the jaw and/or side of the canine's head once the hood is donned.

The head harness fasteners 234a, 236a, 238a and mating hood fasteners 234b, 236b, 238b may comprise various mating fasteners that provide for quick connection and release while allowing secure removable coupling of the mating fasteners. As one non-limiting example, the head harness fasteners 234a, 236a, 238a and mating respective hood fasteners 234b, 236b, 238b may comprise a peg 234c, 236c, 238c and opening 234d, 236d, 238d fastener, as shown in FIG. 2C. The hood 200 includes a tab 234e, 236e, 238e (i.e., a piece of material) extending from an interior surface of the hood. The tab 234e, 236e, 238e includes the hole or opening 234d, 236d, 238d for receipt of the peg 234c, 236c, 238c therethrough. Thus, each set of mating head harness fastener and hood fastener includes a similar peg and hole fastener. In alternative embodiments, the hole or opening is formed on the harness, and the tab extending from the interior surface of the hood includes the peg. Other fastening assemblies may be used, such as mating snaps comprising each of the mating head harness fastener and hood fastener, buckles, D-rings, and similar quick-coupling fastening assemblies. The number and/or placement of fastening assemblies on both internal head harness 204 and head enclosure 206 may vary. For example, depending on the material used to construct hood body 202, the size of the hood and head harness, the breed of canine, and other factors, fewer or more fastening assemblies may be employed to secure head enclosure 206 to internal head harness 204.

FIGS. 2A-2C illustrate the plurality of fastening assemblies 234, 236, 238. In FIG. 2C, the pegs 234c, 236c mounted on respective top and left lateral side of the harness are illustrated. As shown in FIG. 2B, the first fastening assembly 234 comprises the head harness fastener 234a located on the internal head harness 204 at the general top of the canine's head when the harness is donned by the canine, and the hood fastener 234b located at a general underside of a top of the hood when donned by the canine. The peg 234c is disposed on vertical bridging strap 232 corresponding generally to the top of the head 108 of the canine 102; peg 236c may be disposed on the left lateral side of the snout strap 228; and peg 238c (see FIG. 2A) may be disposed on a right lateral side of the snout strap 228.

During an environmental risk, an operator may be under a significant time restraint, heightened anxiety, or other reasons that may cause difficulty in donning portions of canine respirator 100. To aid the operator in placing and securing head enclosure 206 during such a stressful time, the plurality of fastening assemblies 234, 236, 238 may include visual aids, such as color indicators, symbols, or tactile aids, to help in aligning the fasteners. By way of non-limiting example, one set of fastening assemblies (e.g., 234a, 234b) may be colored a first color (e.g., red) to indicate mating of the red-colored hood and head harness fasteners, while a second set of fastening assemblies (e.g., 236a, 236b) may be colored a second color (e.g., blue), and similarly for a third set (e.g., 238a, 238b) of mating hood and head harness fasteners. This allows the operator to quickly associate the mating fasteners during donning. Any visual indicator or tactile indicator may be implemented to aid the operator.

Through such coupling between the internal head harness 204 and the hood 200, the alignment of hood 200 is increased leading to numerous benefits. First, coupling the internal head harness 204 to the head enclosure 206 aids in moving the head enclosure 206 relative to the movements of the canine 102, as described above. This is particularly beneficial in maintaining alignment of the viewing window with the eyes 114 of the canine and for keeping the air intake outlets near the snout of the canine. Second, fastening the head enclosure 206 to the internal head harness 204 further aids in keeping the hood 200 coupled to the canine 102. For example, even trained service canines may react unpredictably during an environmental risk and may react negatively to the hood 200 being placed over the canine's head 108. A canine may even attempt to remove the hood 200. By coupling the head enclosure 206 to the internal head harness 204, the chance of the canine 102 removing the hood 200 by its own volition is reduced or even eliminated. Some embodiments are contemplated in which hood 200 does not comprise internal head harness 204. Further, a canine 102 may be trained to wear hood 200 such that the canine 102 would not attempt to remove the hood 200.

### Body Harness of the Canine Respirator

An exemplary embodiment of the body harness 300 of canine respirator 100 for placement on the canine's body 106 is depicted in FIG. 3. In some embodiments, the body harness 300 may act as an attachment apparatus for one or more additional parts, components, or assemblies of the canine respirator 100 and includes a canine body sleeve 302, at least one harness strap 304, and a handler assistance hub 320.

The canine body sleeve 302 of the body harness 300 may be adapted and configured for placement around the body of the canine. Accordingly, canine body sleeve 302 may be a jacket, vest, harness, or other article of clothing, apparel, or material for wrapping around and securing to the body of the canine. For example, in some embodiments, the canine body sleeve 302 may be a jacket covering a majority of the surface area of the body 106 of the canine 102. In further embodiments, canine body sleeve 302 may be a strap-style harness, in which portions of the body 106 are uncovered and are exposed. Accordingly, the dimensions, shape, and design of the canine body sleeve 302 may vary depending on the embodiment, but generally, is an article for wrapping around the body 106 of the canine 102.

The canine body sleeve 302 may be used with a variety of different breeds of canines, and accordingly, may include varying dimensions based on the size of the canine. Because the dimensions of the canine body may vary, the dimensions of the canine body sleeve 302 correspondingly may vary, but generally, may be adapted for secured and fit placement around the body 106 of the canine 102.

In some embodiments, the canine body sleeve 302 may be constructed or manufactured from a variety of materials. For example, the canine body sleeve 302 may be constructed from a durable material advantageous for military or other service applications. For example, canine body sleeve may be constructed from materials including, but not limited to, polypropylene, nylon, polyester, among other materials. In further embodiments, canine body sleeve 302 may include inserts or areas of selective placement of durable materials, such as Kevlar® or other protective materials for the canine.

Canine body sleeve 302 may further incorporate the use of visual indicators 324 to aid in the visibility of the canine respirator 100. The visual indicators 324 may be bright colors, light elements, reflective material, or other indicators to make the canine body sleeve 302 contrast against the environment, or otherwise make the canine 102 and/or canine respirator 100 more visible to other persons. For example, the visual indicators 324 may be powered safety lights that may be attached to or incorporated into canine body sleeve 302. To make the canine body sleeve 302 more visible, the operator may turn the powered safety lights on to cause a light to be emitted. In further embodiments, canine body sleeve 302 may be partially, or entirely, manufactured from a reflective or bright-colored material, acting as an inherent visual indicator 324. For example, canine body sleeve 302 may be manufactured from a neon green or neon orange fabric that is reflective or otherwise increases visibility of the canine 102. In even further embodiments, canine body sleeve 302 may incorporate a reflective material, such as mirrors or luminescent material acting as the visual indicator. In embodiments, canine body sleeve 302 may incorporate a combination of visual indicators 324 such as incorporating powered safety lights while simultaneously being manufactured from a reflective fabric. In further embodiments, the visual indicators 324 may be incorporated into other portions of the canine respirator 100, including placing one or more visual indicators 324 on the hood 200. For example, visual indicators 324 may be placed on the skirt 212 of the hood 200.

To secure canine body sleeve 302 to the anatomy of the canine 102, body harness 300 further includes at least one harness strap 304 for placement around the body 106 of the canine 102. The at least one harness strap 304 comprises a first portion 306 and a second portion 310, operatively coupled to the canine body sleeve 302 at two opposing attachment points that couple together to secure the canine body sleeve 302 to the body 106 of the canine. For example, each of first portion 306 and second portion 310 may extend to the underbelly or underside of the body 106 of the canine 102, couple together, and be tightened to securely fasten the canine body sleeve 302 against the body 106 of the canine.

For example, in some embodiments, a first portion 306 of the strap 304 may be coupled at a first location on the canine body sleeve 302 and extend around the body 106 of the canine 102. The first portion 306 of the strap 304 may include a fastener 308. To secure the strap 304, a second portion 310 of the strap 304 may be coupled at a second location on canine body sleeve 302 and extend around the body 106. The second portion 310 of the strap 304 may include a complementary fastener 312 for fastening with the fastener 308 of the first portion 306, thereby coupling the second portion 310 to the first portion 306. For example, the fastener 308 and complementary fastener 312 may be a male and female buckle of a buckle fastener, respectively. In further embodiments, the fastener 308 and the complementary fastener 312 may be compatible components of a COBRAR fastener system. However, it will be appreciated that the fastener 308 and the complementary fastener 312 may be any design of mechanical fasteners.

As depicted, the canine body sleeve 302 may include a plurality of straps 304 selectively positioned at advantageous positions on the canine body sleeve 302 for securing the body harness 300 to the canine 102. For example, in some embodiments, the canine body sleeve 302 may include at least one strap 304 positioned approximately at the location where the neck 110 of the canine 102 meets the body 106 of the canine 102. Additionally, the canine body sleeve 302 may include at least one strap 304 positioned approximately between the forequarters 120 and the hindquarters 122 of the canine 102. In further embodiments, canine body sleeve 302 may include two or more straps 304 positioned between the forequarters 120 and the hindquarters 122.

In some embodiments, the canine body sleeve 302 may further include a handler assistance hub 320 to aid a handler or operator in the donning of the canine body sleeve 302 and/or for handling the canine 102 after donning. The handler assistance hub 320 includes a graspable handle 314 and leash hardware 316.

The graspable handle 314 is a hand-graspable loop of material, positioned on the canine body sleeve to aid a human operator in controlling the canine 102 or lifting the canine. The graspable handle 314 may be positioned at varying positions on the canine body sleeve 302. For example, the graspable handle 314 may be located approximate to the back 134 of the body 106, providing a leverage point for the operator when handling the canine 102. However, the graspable handle could be located approximate to a left or right side of the body 106. In further embodiments, a plurality of graspable handles 314 may be disposed on canine body sleeve 302, providing an operator with multiple grasping points.

In some embodiments, the graspable handle 314 may also comprise a grasping aid 322 to aid the operator or handler in maintaining a grip of the graspable handle 314. For example, the grasping aid 322 may be a molded piece of rubber wrapped around graspable handle 314. In further embodiments, the grasping aid 322 may be textured material. However, grasping aid 322 may comprise any design for aiding an operator or handling in gripping graspable handle 314. For example, in stressful situations such an environmental risk, even trained and obedient canines 102 may act out in fear or surprise. Accordingly, a graspable handle 314 positioned on the canine body sleeve 302 may aid an operator during donning, maintaining control of the canine 102 after the canine respirator 100 has been donned, among other purposes.

The leash hardware 316 is an attachment point for a leash (not shown), allowing an operator to couple a leash to the harness 300. Accordingly, leash hardware 316 may be loops, clips, buckles, or other fasteners positioned on the canine body sleeve 302 for coupling to a leash (not shown). The leash hardware 316 may be disposed at any position on the exterior of canine body sleeve 302. For example, the leash hardware 316 may be located approximate to the back 134, providing a convenient location for the operator to access.

In some embodiments, the location of grasping handle 314 and leash hardware 316 may be selectively placed to provide convenience to the operator and comfort to the canine 102. For example, as depicted in FIG. 3, the leash hardware may be located approximate to the anterior side 126 of the canine 102 and the graspable handle 314 may be located approximate to the posterior side 128 of the canine 102.

### Fastening Body Harness to Hood

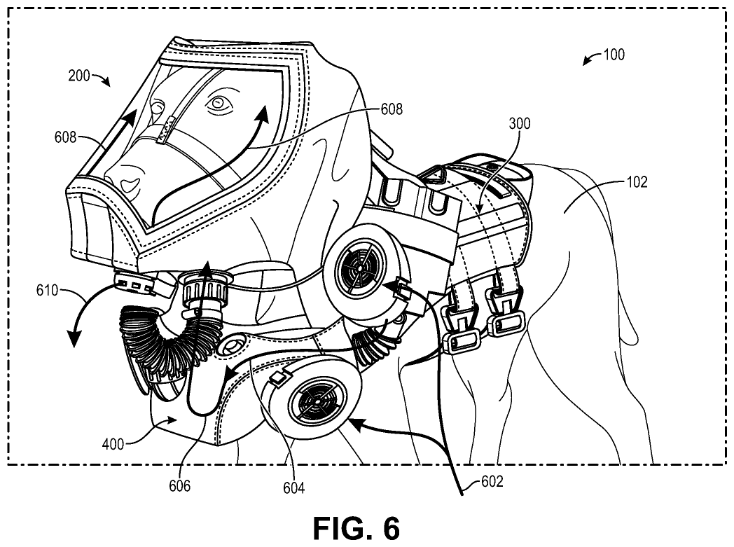

As shown in FIGS. 1A, 1B, and 6, at least a portion of the hood 200 and the body harness 300 couple or otherwise connect. Specifically, the skirt 212 of the hood 200 is removably couplable with the body harness 300 via one or more skirt fasteners 242, as described above. The one or more skirt fasteners 242 may be used to couple the skirt 212 to the canine body sleeve 302 to aid in keeping the skirt 212 secured to the harness 300 and by extension to the body 106 of the canine 102.

To couple the canine body sleeve 302 to the skirt 212, the canine body sleeve 302 may include one or more harness fasteners 318 for coupling with skirt fasteners 242. Accordingly, the one or more harness fasteners 318 are complementary fasteners to the skirt fasteners 242. For example, if skirt fasteners 242 comprise hook and loop fasteners, then the one or more harness fasteners 318 are compatible hook and loop fasteners. In further embodiments, if skirt fasteners 242 are male buckles, then the one or more harness fasteners are female buckles.

In some embodiments, the canine body sleeve 302 may include a plurality of harness fasteners 318 corresponding to the number of skirt fasteners 242. However, in further embodiments, the canine body sleeve 302 may include a greater number of harness fasteners 318, providing an operator with greater flexibility and options when coupling the skirt 212 to the canine body sleeve 302. Accordingly, the location and positioning of the harness fasteners may be selectively placed on the canine body sleeve 302.

Through the coupling of skirt 212 to canine body sleeve 302, several benefits may be realized. First, securing the excess material comprising the skirt 212 to the canine body sleeve 302 reduces or eliminates the risk of the skirt from snagging or catching against objects and/or reduces the chance of harmful particulates, particles, droplets, and/or vapor coming into contact with the skin of the canine 102. Second, securing the skirt 212 to the canine body sleeve 302 provides additional securing of the hood 200 to the canine 102. Particularly, additional attachment points at different positions increases the overall securement of hood 200 after donning, decreasing the risk of the canine 102 from pulling the hood 200 off.

### Air Supply Unit

During a prolonged environmental risk, merely preventing the inhalation or exposure of harmful particulates, particles, droplets, and/or vapor may not be enough to keep a canine alive and unharmed. The amount of usable air that may be trapped in the hood 200 may be exhausted by the canine 102 prior to escape or rescue. Accordingly, embodiments of the canine respirator 100 further includes an air supply unit 400 for filtering and delivering clean, purified, or fresh air (e.g., filtered air or air supplied from an external air source) to the canine 102 for consumption (see FIGS. 4A and 4B). The air supply unit may comprise a mounting assembly 402 for coupling the air supply unit 400 to the canine and a motor system 414 for drawing in and filtering air from the environment.

### Mounting Assembly of Air Supply Unit

To mount or couple the air supply unit 400 to the canine 102, air supply unit 400 comprises a mounting assembly 402 for quickly and efficiently removably securing the air supply unit to the canine, such that the air supply unit 400 is carried by the canine. A canine 102 outfitted with the canine respirator 100 is still able to walk, run, and maneuver with the mounted air supply unit 400. In embodiments and as illustrated in FIGS. 4A-5, the mounting assembly 402 comprises a collar 404 that is positionable around the canine's neck 110 or body 106 via complementary fasteners for coupling the air supply unit 400 to the canine 102.

The collar 404 comprises a length of material for wrapping around the neck 110 of the canine 102 with fasteners to secure collar 404 in place. By way of non-limiting example, collar 404 may include a first end 406 having a first collar fastener 408 and a second end 410 having a second collar fastener 412. The first collar fastener 408 and the second collar fastener 412 are compatible mechanical fasteners for securing the first end 406 and the second end 410 together to secure the collar 404 to the canine 102. Exemplary collar fasteners 408, 412 include corresponding hook and loop fasteners, such as VELCRO®, corresponding halves of a COBRA® fastening system, or other quick release fastening system, such as buttons, buckles, snaps, magnets, etc.

The collar 404 may further comprise additional fasteners similar to collar fasteners 408, 412 to provide further connection between air supply unit 400 and hood 200 and/or air supply unit 400 and harness 300. The additional fasteners may comprise one or more fasteners compatible to at least one of skirt fasteners 242 on hood 200 and one or more fasteners 318 on harness 300. The additional fasteners may be any combination of hook and loop fasteners, corresponding halves of a COBRAR fastening system, buttons, snaps, and magnets, as well as any other suitable quick release fastening system.

The collar 404 may be constructed and manufactured having varying designs and may be made from a variety of materials. For example, in some embodiments, the collar 404 may be constructed from a webbing material, including but not limited to nylon, polypropylene, polyester, among other materials. In other embodiments, the collar 404 may be constructed from a non-webbing material, such as leather, rubber, or other materials. The materials used to construct the collar 404 may be dependent on factors including but not limited to the rating that the canine respirator 100 is rated to protect against an environmental risk, whether the collar 404 is single use or reusable, among other factors.

In embodiments, the mounting assembly 402 including the collar 404 comprises one or more mounting brackets utilizing strapping and a fitted pocket located on the collar 404 for mounting the components of the air supply unit 400 to the collar 404, which is useful in storing the air supply unit 400 when not in use, reducing the time to don the air supply unit 400, maintaining a position of the air supply unit 400 during use, among other reasons. For example, prior to donning the collar 404 onto the canine 102, one or more components of the air supply unit 400 are attached to the collar utilizing the fitted pockets located on the collar 404. In embodiments, the one or more components are placed into the fitted pockets and retained through an interference fit between the component and the fitted pockets. In further embodiments, the one or more components may be retained using mechanical fasteners, providing either permanent or semi-permanent attachment of the components to the collar 404. For example, the mechanical fasteners may be one or more straps, screws, clamps, or other fasteners.

### Motor System of Air Supply Unit

The motor system 414 of the air supply unit 400 provides the machinery, circuitry, filters, etc., to filter air containing harmful particulates, particles, droplets, and/or vapor into breathable air for use by the canine. Broadly, motor system 414 may cause the drawing in of air from the environment, filtering of the air, and delivering of the fresh air (e.g., filtered air or air supplied from an external air supply) to the canine 102 for consumption. The motor system 414 comprises a main manifold 416, one or more main filters 424, 426, a power source such as a battery 434, and transport tubing, such as transport hose 432 and air tube 442. In some embodiments, motor system 414 further comprises a secondary filter manifold 417 comprising second battery 438 and secondary filters 428, 430, as depicted in FIG. 4B.

Referring to FIGS. 4A and 4B, the main manifold 416 houses the circuitry and structure to cause the drawing in of air from the environment, filtering in the drawn in air, and causing the transportation of the fresh air to the hood 200 for use by the canine 102 for consumption. The main manifold 416 includes main body 418 housing or providing mounting for at least one input 420, at least one main manifold inlet 450, a main manifold outlet port 422, and the one or more filters (e.g., first main filter 424 and second main filter 426). Main body 418, first main filter 424, and second main filter 426 may be constructed from a durable material, such as hardened plastics or other synthetic polymers. Main body 418 further comprises a control system 500, providing the circuitry for powering on and using the air supply unit 400. The control system 500 is described below with respect to FIG. 5.

The at least one input 420 may be a selectable input for controlling one or more aspects of the motor system 414. By way of non-limiting example, input 420 may be a button, a toggle switch, or other selectively activatable input or controls. In some embodiments, main body 418 may include additional inputs 420 that may control one or more additional features of motor system 414. For example, in some embodiments, a first input 420 may power the motor system 414 off and on while a second input 420 may adjust the flow rate of fresh air delivered to the hood 200. In embodiments, the input 420 may be a display that includes a touchscreen, buttons, or other controls for navigating and selecting available features provided through the display.

The main manifold outlet port 422 is an opening located on the exterior of the main body 418 for directing the fresh air out of the main body 418. The outlet port 422 is fluidly connected to an internal channel or pathway located within the main body 418 for receiving fresh air. The outlet port 422 is fluidly connected to the air tube 442 to transport the fresh air to the hood 200. Similar to air entry port 218, the outlet port 422 may be adapted and configured with a self-sealing end to prevent the inadvertent release of fresh air from the main body 418 and/or to prevent contaminated air from entering the main body 418.

As noted above, motor system 414 includes at least a first main filter 424 and an optional/additional second main filter 426, each of which may be any known filter that may be used in an air supplying apparatus, but generally may include filters or other purifying elements to filter and/or purify air drawn in from the environment. However, the total number of filters may vary, depending on the embodiment. The first main filter 424 comprises a filter body 460, a filter inlet 462, a filter channel 464, at least one filter 466, and a filter outlet 468. Similar to the main body 418, the filter body 460 houses or otherwise supports the first main filter 424. The filter inlet 462 is fluidly coupled to the filter channel 464 located within the interior of the filter body 460. The filter inlet 462 is an opening or void located on the filter body 460, providing an opening for air from the environment to be drawn into the filter body. The filter inlet 462 may be positioned at any point on the filter body 460, including for example, a top portion of the filter body 460.

The filter channel 464 is a channel disposed within the interior of the filter body 460, providing a fluid pathway for the drawn in air received via the filter inlet 462. The filter channel 464 extends the entire length of the filter body 460 terminating at the filter outlet 468. The filter channel 464 is fluidly coupled to the inner channel of the main body 418 to allow the drawn in air to be transferred from the filter body 460 to the main body 418. In some embodiments, the filter outlet 468 terminates or joins with the inner channel of the main body 418. In further embodiments, the filter outlet 468 terminates or joins with tubing, a hose, or other transport apparatus, including transport hose 432 as described in greater detail below. However, whether by a direct joining or indirect joining by tubing, the filter channel 464 is fluidly coupled to the main body 418.

To filter, purify, or otherwise remove harmful particulates from the drawn in air, filter body 460 further incorporates the at least one filter 466. The filter 466 is a particulate filter that removes or captures particulates present in the drawn in air. For example, the filter may be a high efficiency particulate air (HEPA) filter and/or a chemical, biological, radiological, and nuclear (CBRN) filter. The filter 466 may be located within the filter channel 464 at a position downstream of filter inlet 462 but upstream of the filter outlet 468, such that the drawn in air passes through the filter 466 prior to entering the main body 418. In embodiments, a plurality of filters 466 may be utilized and located within the filter body 460.

The first main filter 424 was described in the above paragraphs, but it is noted that in embodiments of the invention, the motor system 414 further includes the second main filter 426, which is substantially similar to the first main filter 424 and comprising similar components, such as filter body 460, filter inlet 462, filter channel 464, at least one filter 466, and filter outlet 468. As shown in FIG. 4A, the first and second main filters 424, 426 may be disposed on opposite sides of the main body 418. Alternatively, the first and second main filters 424, 426 may be disposed in any position relative to main body 418.

In addition to the one or more main filters 424, 426, embodiments of the motor system 414 include at least one secondary filter 428. The secondary filter 428 may be an optional and/or additional filter utilized by the air supply unit 400 for filtering air from the environment. As described above, canines have significant oxygen requirements (i.e., oxygen requirements above those of a human), and accordingly, require significant fresh air during an environmental risk. Each secondary filter 428 may be substantially identical to first main filter 424 and second main filter 426 and comprise a filter body 460, a filter inlet 462, a filter channel 464, a filter 466, and a filter outlet 468. The total number of filters may vary, and for example, may be dependent on the desired protection rating or other factors. Accordingly, the air supply unit 400 may have a varying and selectively implemented number of filters, including at least one filter, two filters, three filters, four filters, five filters, or six or more filters.

### Powering the Motor System

In some embodiments, the motor system 414 may utilize at least one battery 434 for powering portions of motor system 414. The at least one battery 434 may provide power to the main body 418, including any circuitry or fans disposed within the main body 418. The at least one battery 434 may be any power source, such as lithium batteries, alkaline batteries, nickel metal hydride batteries, or other types of batteries. Further, the at least one battery 434 may be a rechargeable battery, capable of being recharged after depletion, or a disposable battery which may be replaced after depletion.

In some embodiments, the at least one battery 434 may be the primary power source for main body 418. For example, in some embodiments, main body 418 may not have an internal battery to reduce the form factor of main body 418. In further embodiments, the at least one battery 434 may operate as a secondary battery or a backup battery for a primary battery. For example, in some embodiments, main body 418 may include an internal battery providing the primary battery source. In the event of failure or after consuming the stored energy of the primary battery, the at least one external battery may provide additional power to main body 418.

In some embodiments, the at least one battery 434 may attach to mounting assembly 402 through a battery housing 436. In some embodiments, battery housing 436 may be attached to a portion of mounting assembly 402 or alternatively, may be attached to another portion of motor system 414. For example, in the depicted embodiments, battery 434 may couple or attach to the body of at least one filter, including first main filter 424, second main filter 426, first secondary filter 428, and second secondary filter 430. However, the location of battery housing 436 may be located at any position on mounting assembly 402 and/or motor system 414. In further embodiments, the battery housing 436 may be located internally within main body 418, with at least a portion of the at least one battery 434 located within main body 418,

As further depicted, in some embodiments, motor system 414 may include a second battery 438 to provide additional usage to motor system 414. Similar to battery 434, the second battery 438 may also include a battery housing 440. However, air supply unit 400 may utilize any number of batteries, providing for extended use of the canine respirator 100. Additionally, air supply unit 400 may comprise one or more indicators 476, 478 such that the battery level of the battery may be communicated to a human operator as described below. As shown in FIG. 4B, perspective view 451 depicts a front view of a portion of motor system 414 comprising input 420 and one or more indicators 476, 478 according to some embodiments.

### Transport Tubes

To deliver and transport fresh air, air supply unit 400 comprises tubing, including transport hose 432 and air tube 442. The transport hose 432 may be used to deliver fresh air from any filters that are not physically coupled to the main body 418, e.g., the secondary filters 428 and 430. The air tube 442 is used to deliver fresh air from the main manifold 416 to the hood 200. Embodiments are contemplated in which transport hose 432 and/or air tube 442 may be connected to an external air supply, such as any air supply discussed herein, such that fresh air is provided to hood 200.

The transport hose 432 may be a tubular or other similar design structure having a hollow passageway or channel for the transporting of fresh air from the filters to the main body 418. As depicted in FIG. 4A, the transport hose 432a may include an open first end 470a that couples to main body 418 and an open second end 472a that couples to at least one of the filters, including the first main filter and/or secondary filter 428. In embodiments comprising more than one filter, e.g., secondary filters 428, 430, a second transport hose 432b may be used. Second transport hose 432b comprises an open first end 470b that couples to the main body 418 and an open second end 472b that couples to at least one of the filters, including the secondary filter 430 as depicted in FIG. 4A. As further depicted, the transport hose 432a couples to the main body 418 at a first position, and the second transport hose 432b couples to the main body 418 at a second position.

Embodiments are contemplated in which a third transport hose 432c may be used to couple at least one filter (e.g., secondary filter 430) and main body 418 as depicted in FIG. 4B. Further, transport hoses 432a, 432b, 432c may be coupled or otherwise combined into a single transport hose 432. For example, transport hose 432 may comprise at least a portion of transport hoses 432a, 432b, 432c such that each transport hose 432a, 432b, 432c may couple at least one filter and the main body 418 at the at least one main manifold inlet 450. Further, transport hoses 432a, 432b, 432c may each be a portion of a tubing system configured to attach each filter to the main body. For example, the tubing system may comprise a portion of transport hoses 432a, 432b, 432c that couple the one or more filters of air supply unit 400 to main body 418 via a single open end 472. As depicted in FIG. 4B, the transport hose 432 may couple one or more filters of air supply unit 400 and main body 418 such that a fluid channel 474 is provided between the one or more filters and the main body 418.

By way of non-limiting example, the transport hose 432 may be a butyl rubber hose. However, the material used for constructing or manufacturing the transport hose 432 may vary. In further embodiments, the internal passageway or channel of the transport hose 432 may be coated with an anti-microbial, anti-fungal, and/or antiviral material to provide additional filtering of the drawn air as the air is transported through the transport hose 432. By way of non-limiting example, the interior of the transport hose 432 may be coated with a silver, copper, nickel, or other coating for anti-microbial, anti-fungal, and/or antiviral purposes.

In embodiments, the air tube 442 may be a tube having a continuous fluid passage or fluid channel 474 for the transportation of fresh air. The air tube 442 includes an open first end 444 coupled to the air supply unit 400 and an open second end 446 coupled to the hood 200. For example, the open first end 444 may couple to the outlet port 422 located on the main body 418 and the open second end 446 may couple to the air entry port 218 located on the hood body 202.

To aid in protection of the canine 102 from an environmental risk, open first end 444 and/or open second end 446 may further include a self-sealing end, including, for example, self-sealing ends 448a, 448b respectively. In embodiments, the self-sealing ends 448a, 448b may be adapted and configured to automatically seal when the air tube 442 is disconnected from the head enclosure 206 and/or the air supply unit 400. The self-sealing ends 448a, 448b may include valves configured to automatically seal when disconnected from the head enclosure 206 and/or the air supply unit 400. The self-sealing ends 448a, 448b may accordingly, provide protection to the inner cavity of the air tube 442 when the air tube 442 is disconnected. Through such protection, the inner cavity of the air tube 442 is protected from the introduction of contaminants and/or environmental particulates. In some embodiments, the connection between air tube 442 and the head enclosure 206 may be a permanent connection such that the hood 200 and the air supply unit 400 are permanently connected to further prevent the introduction of contaminants and/or environmental particulates.

For additional decontamination effects and/or cleaning purposes, inner surface of the air tube 442 may be coated with an antimicrobial, anti-fungal, and/or antiviral material. For example, embodiments of air tube may include copper, silver, or other material for antimicrobial, anti-fungal, and/or antiviral purposes.

### System Architecture of Canine Respirator

Referring to FIG. 5, the respirator 100 includes control system 500, which may be a processor or other circuitry, or computer hardware housed within the main body 418 for receiving or relaying commands to one or more components of the air supply unit 400. For example, responsive to a command received from the input 420, the control system 500 may send instructions for the air supply unit 400 to begin drawing in air from the environment. The motor system 414 may be configured and adapted for controlling the flow rate of the air drawn in from the environment and/or for the flow rate of delivering air to the hood 200. To cause the drawing in of air from the environment, the motor system 414 may include at least one motor 504 and at least one fan 510 (see FIG. 5). For example, in some embodiments, the at least one fan may be located within the interior of the main body 418. Responsive to a command or instruction recited from the control system 500, the motor may cause the at least one fan to begin spinning to cause the drawing in of air from the environment. Air may be drawn in from one or more manifolds attached to the motor system 414.

The rate at which the at least one fan spins controls the rate at which air is drawn in from the environment. Additionally, the rate at which the at least one fan spins may also control the rate at which fresh air (e.g., filtered air or air supplied from an external air source) may be delivered to the hood 200. For example, the at least one fan may spin at a rate to draw in and deliver air to the hood 200 at a rate of approximately 300 liters per minute. However, the at least one fan may spin at a rate to draw in and deliver air at varying rates, including from approximately 10 liters per minute to approximately 500 liters per minute. The rate of the at least one fan may vary during the time the air supply unit 400 is powered on. For example, if the canine 102 is panting, the at least one fan can be instructed to spin faster to deliver additional fresh air to hood 200 for the canine.

In embodiments, the flow rate may be a predetermined and constant flow rate. In embodiments, the at least one fan spins at a constant, or non-varying, rate corresponding to a maximum air flow rate. For example, approximately 300 liters per minute of fresh air may be delivered into the hood 200 at a constant rate. In further embodiments, the flow rate may be variable or selectively changed, through manual inputs or by an automated process. For example, the canine respirator 100 may comprise one or more sensors for measuring certain parameters, such as temperature, CO₂ levels, humidity levels, pressure levels, among other parameters. The measurements may be utilized in determining whether the flow rate should be increased or decreased. The process of utilizing sensors is described in greater detail below with respect to FIG. 5.

FIG. 5 depicts an exemplary block diagram related to controlling the air supply unit 400 and more specifically, the motor system 414. As depicted and described herein, the control system 500 may control the motor system 414 of the air supply unit 400 and may communicate wirelessly with a client device 520 for receiving instructions or commands or for relaying other information to the client device.

The control system 500 may comprise a controller 502 for controlling at least one motor 504, a battery control 506, a fan control 508 for controlling the at least one fan 510, a sensor control 512 for monitoring one or more sensors 514, a local memory 516, and an optional transceiver 518.

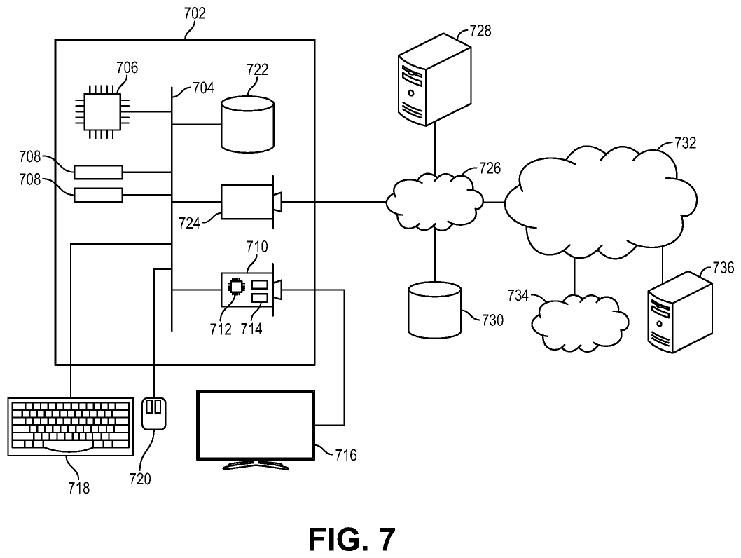

As described herein, the controller 502 may receive instructions and relay instructions to the remaining components of the control system 500. In some embodiments, the controller 502 may be a processor or other circuitry or computer hardware for receiving commands or instructions and causing the execution of the commands. For example, the controller 502 may be analogous to the central processing unit (CPU) 706, as described below with respect to FIG. 7. Accordingly, in some embodiments, instructions or commands from the controller 502 may be sent to each of the battery control 506, the fan control 508, the sensor control 512. For example, responsive to instructions received from input 420, controller 502 may cause the motor system 414 to turn on by sending instructions to at least one motor 504. Additionally, instructions from controller 502 may be sent to the fan control 508 to increase the flow rate of the fresh air. Further, controller 502 may be in communication with transceiver 518 for communicating with the client device 520 to send information or data or to the client device 520. Similarly, controller 502 may further be configured for receiving instructions, commands, or other information from the client device 520.

The controller 502 is in communication with at least one motor 504 of the motor system 414 housed within the main body 418. The at least one motor 504 is an electrical machine converting the stored power from the at least one battery 434 to power the components, parts, and circuitry of the air supply unit 400. Through the conversion of stored powered, the at least one motor 504 provides energy to spin the at least one fan 510, causing the drawing in of air from the environment.

In some embodiments, control system 500 further comprises a battery control 506 for powering one or more parts or components of control system 500 and/or motor system 414. In some embodiments, the battery control 506 may receive inputs from controller 502 to power the at least one motor 504 of the motor system 414, causing the at least one motor 504 to draw power from the at least one battery 434. Conversely, the battery control 506 may also receive inputs from controller 502 to turn off the at least one motor 504 of the motor system 414, causing the motor system 414 to stop drawing power from the at least one battery 434. In further embodiments, battery control 506 may monitor the battery life of the at least one battery 434. For example, in embodiments of canine respirator 100 comprising a first battery and a second battery, the battery control 506 may monitor the battery life of each battery and upon detecting the first battery is running low on stored power, may cause the motor system 414 to start drawing power from the second battery. Additionally, battery control 506 may control one or more indicators 476, 478 to communicate the battery life of one or more batteries to a human operator of the canine respirator 100. For example, in embodiments of canine respirator 100 comprising a first battery and a second battery, indicator 476 may indicate the battery life of a first battery and indicator 478 may indicate the battery life of a second battery.

In embodiments, control system 500 further comprises fan controls 508, which may control the speed at which the one or more fans 510 located within the main body 418 rotate. As described above, the rotation of the one or more fans 510 affects the rate at which air is drawn in from the environment and the rate at which fresh air is introduced into the hood 200. The fan controls 508, responsive to receiving instructions from the controller 502, control the rotational speed of the one or more fans 510. For example, responsive to a determination that the canine 102 requires more fresh air, whether for oxygen requirements or to add additional circulation in the breathable zone, the controller 502 can send a command to the fan controls 508 to increase the rotational speed of the one or more fans 510. Conversely, responsive to a determination that the canine 102 requires less fresh air, the controller 502 can send a command to the fan controls 508 to decrease the rotational speed of the one or more fans 510. Accordingly, the canine respirator 100 provides for dynamic control and granular selection of fan rotation speed to selectively control the flow rate of fresh air to the hood 200. In embodiments comprising multiple fans 510 housed within the main body 418, the fan controls 508 may instruct each fan 510 to spin independently, providing for greater control of the flow rate of air.

In embodiments, canine respirator 100 may comprise one or more sensors 514 for recording different data points that may affect the flow rate of the fresh air. Accordingly, control system 500 may comprise a sensor control 512 for receiving and processing sensory information and data collected by one or more sensors. For example, the hood 200 may comprise one or more sensors 514 within the interior of the head enclosure 206 for monitoring the oxygen levels, carbon dioxide levels, and/or flow rate of fresh air within the breathable zone 208, among other data points. Additionally, the main body 418 may also comprise one or more sensors 514 for monitoring the oxygen levels, carbon dioxide levels, flow rate of incoming air drawn in from the environment. However, different sensors 514 may be incorporated and disposed on various positions on canine respirator 100.

Local memory 516 may be any of the storage or memory described below with respect to FIG. 7. Local memory 516 stores computer-readable instructions for access by the controller 502. Further, local memory 516 may store sensory information captured from the one or more sensors. Storing the sensory information at the local memory 516 can then be accessed at a later time for analysis or diagnostic purposes.

The control system 500 may further incorporate a transceiver 518 to facilitate communications with external hardware, including for example client device 520. The transceiver 518 is operable to transmit and receive a wireless or wired signal which may perform a function, such as sending sensory information or receiving instructions for the canine respirator from the client device 520. For example, transceiver 518 may be adapted and configured to send signals through a wireless connection, such as such as Wi-Fi, Bluetooth®, cellular connection, or another wireless connection.

In some embodiments, the control system 500 communicates with a client device 520, the client device 520 being the medium for receiving user inputs. Accordingly, the client device 520 may be an interface, apparatus, or system providing a user with an interactive medium for inputting instructions and comprises a display 522, controls 524, and a communication element 526. For example, the client device 520 may be a smartphone running an application. The display 522 is a monitor, touchscreen, television screen, or other display with reference to FIG. 7 below. Accordingly, the display 522 may display to the operator the application running on the client device 520, display information received from the canine respirator 100, among other functions. Controls 524 may be an interactive medium for receiving operator instructions, inputs, or commands for instructing particular actions for the canine respirator 100. For example, controls 524 may be a touchscreen, buttons, joysticks, or other interactive media for receiving operator inputs. Communication element 526 is circuitry or other media for sending and receiving signals, data, or other communication. For example, communication element 526 may be a wireless communication transceiver for sending and receiving communication to and from the transceiver 518 of the control system 500.

In further embodiments, the client device 520 may be integrated into the air supply unit 400, in addition to or in place of an independent device. For example, in embodiments, the display 522 may be integrated or incorporated into the main body 418, providing an interface for the operator to be provided with information. Additionally, controls such as buttons, knobs, a touchscreen, or other inputs may also be incorporated into main body 418. Accordingly, the operator may input instructions and receive information directly from the air supply unit 400. Integrating the client device 520 into the air supply unit 400 may be particularly advantageous for applications in remote areas that have little to no wireless communication capabilities.

### Method of Placement of the Canine Respirator

Embodiments of the canine respirator 100 may be utilized by canines 102 deployed in a variety of settings, applications, or scenarios with a pre-determined threat level of an environmental risk. Depending on the scenario, the canine 102 may start with some portions of canine respirator 100 already donned and some portions doffed. For example, in a search and rescue situation, a canine 102 may need to rely on its nose for tracking down a missing person. Accordingly, prematurely donning the hood 200 may hinder the canine's ability to track using smell. In other use cases, for example, a military canine performing a search and rescue operation may already be wearing harness 300 or a variation of a harness. Accordingly, when an environmental risk is detected, the human operator can skip the step of donning the harness 300 on the canine 102.

Upon detection of an environmental risk, the human operator may begin donning canine respirator 100 on the canine 102. If the canine 102 is not already wearing the harness 300, an initial step of donning canine respirator 100 may be the securing of harness 300 to the canine 102. The canine body sleeve 302 is positioned on the body 106 of the canine 102 and secured through the fastening of the one or more straps 304. As described above, the one or more straps 304 may include quick release fasteners such as COBRAR fasteners, aiding the operator in quickly donning and securing the canine body sleeve 302 to the canine 102.

After the harness 300 has been secured to the body 106 of the canine 102, the operator may place and secure the hood 200 on the canine 102. As described above, the hood 200 may include a head enclosure 206 and an internal head harness 204. In donning the hood 200, the operator may first place the internal head harness 204 on the head 108 of the canine 102. After the internal head harness 204 has been placed and secured, the operator may then place the head enclosure 206 in place. As described above, the operator may couple the head enclosure 206 to the internal head harness 204 using the plurality of fastening assemblies 234, 236, and 238. Following the attachment of the head enclosure 206 to the internal head harness 204, the hood 200 and the harness 300 may be coupled. Alternatively, the hood 200 and the harness 300 may be coupled without donning the internal head harness 204. To secure the hood 200 to the harness 300, the operator may couple the skirt fasteners 242 to the harness fasteners 318.

After the placement and securing of hood 200 to the canine 102, the operator may then place and secure the air supply unit 400 on the canine 102. As described above, the air supply unit 400 may include a mounting assembly 402 and the operator may place the mounting assembly 402 around the neck 110, shoulders, withers 132, back 134, and/or body 106 of the canine 102 and fasten the mounting assembly 402. In embodiments, although the mounting assembly 402 is secured around the neck 110 of the canine 102, the air supply unit 400 may be positioned to rest or come contact with the body 106 of the canine 102. Particularly, the mounting assembly 402 may be secured at roughly the position were the neck 110 meets the body 106 of the canine 102. Accordingly, portions of the air supply unit 400 may rest against the body 106 of the canine. In particular, portions of the air supply unit 400 may rest against the anterior side 126, the chest 130, the withers 132, and/or the shoulders of the canine 102, alleviating a portion of the weight of the air supply unit 400 from the neck 110. Accordingly, through such mounting, the body 106 of the canine 102 supports a portion of the weight of the air supply unit 400, thereby relieving stress, weight, and pressure away from the neck 110.

Mounting the air supply unit 400 around the neck 110 of the canine 102 with the anterior side 126 of the canine 102 providing support further aids in keeping the movement of the canine 102 unhindered. For example, mounting the air supply unit 400 around the neck 110 of the canine 102 and supported by the anterior side 126 of the canine 102 aids in maintaining the position and alignment of the air supply unit 400, preventing the swaying of the air supply unit 400. Such swaying may make movement more difficult to the canine 102. Additionally, mounting the air supply unit 400 around the neck 110 further aids in keeping the air tube 442 away from the forequarters 120 and the hindquarters 122, preventing the canine 102 from tangling with the air tube 442.

After the mounting assembly 402 has been placed on the canine 102, the operator may then attach the air tube 442 to the main body 418 via connecting the open first end 444 to the outlet port 422. After coupling the air tube 442 to the main body 418, the operator may then couple the air tube 442 to the hood 200 via connecting the open second end 446 to the air entry port 218. In some embodiments, the order of coupling air tube 442 to head enclosure 206 and main body 418 may not matter, and the operator may couple the air tube 442 to the hood 200 first. Alternatively, the air tube 442 may be permanently coupled to hood 200 such that after the hood 200 is donned, air supply unit 400 may be donned without coupling air tube 442 to the hood 200.

In some embodiments, the fresh air supply (i.e., the fresh air provided by air supply unit 400 or by an external air supply) may be bypassed while operating in non-hazardous areas such that air from the environment is provided directly to the hood 200. Further, the air provided directly from the environment may facilitate the dog's tracking abilities during a search and rescue situation. In some embodiments, hood 200 may be donned by canine 102 in a non-hazardous environment and may be configured to receive air from the environment such that the canine's smell is not hindered while wearing hood 200. Further, in the event that a dangerous situation is detected, hood 200 may be switched to a protective state in which fresh air is supplied via air supply unit 400 or an external air supply as discussed herein. In some embodiments, the protective state may be activated in less than 2 minutes, less than 1 minutes, less than 30 seconds, less than 15 seconds, less than 10 seconds, or less than 5 seconds.

As described above, embodiments are contemplated to provide a lightweight system, aiding both the canine 102 and the operator. To provide comfort to the canine 102 and aid the operator in donning, the weight of the hood 200 may be approximately no greater than one pound. However, embodiments are contemplated in which the hood 200 may be approximately half a pound to approximately 2 pounds. Accordingly, embodiments are contemplated in which the canine respirator 100 has a total weight of no greater than 10 pounds. However, in some embodiments, canine respirator 100 may have a weight greater or lesser than a weight of 10 pounds.

### Method of Use of the Canine Respirator

After assembly and placement of the canine respirator 100 on the canine 102 during an environmental risk, the operator can power on the canine respirator 100 to being drawing in air from the environment, filter the drawn air, deliver the fresh air (e.g., filter air) to the canine 102 for consumption, and dispel the consumed air. An exemplary pathway of air is depicted in the pathway illustrated in FIG. 6.

After donning the canine respirator 100 on the canine 102, the operator may power on the motor system 414 to cause the at least one fan 510 in the main body 418 to begin spinning. Responsive to the fan spinning, air from the surrounding environment may be drawn in through the filter inlet 462 of the filter body 460 as shown by direction 602. For example, air may be drawn from the environment via any and all of the filters of the air supply unit 400 (i.e., first main filter 424, second main filter 426, first secondary filter 428, and/or second secondary filter 430). As air is drawn into the filter body 460, the air travels through the filter channel 464 and passes through the filter 466. As the air passes through the filter 466, particulates, particles, droplets, and/or vapor may be removed via the filter 466. The drawn in, and now fresh air, travels through the filter channel until reaching filter outlet 468 and entering either the internal channel of the main body 418 or the transport hose 432a.

If the fresh air is directed to the transport hose 432a, the fresh air may follow the pathway shown by direction 604 for transportation to the main body 418. Upon entering the main body 418, whether directly or via the transport hose 432a, the fresh air is then directed to the outlet port 422. The fresh air then passes through the outlet port 422 and enters the air tube 442. Through the airflow generated by the at least on fan of the motor system 414, the fresh air travels through the fluid pathway of the air tube, through the length of the air tube 442 until reaching the air entry port 218 of the hood 200 as depicted by direction 606.

Once the fresh air has reached the air entry port 218 the fresh air is then directed to the fluidly coupled air intake and distribution system 216. As described above, the air intake and distribution system 216 comprises a first channel 225a and a second channel 225b. After leaving the air entry port 218, the fresh air is directed to each of the first channel 225a and the second channel 225b. The now split air travels through the fluid pathway of each of the first channel 225a and the second channel 225b until reaching the respective open second ends 229a, 229b. Upon reaching the respective open second ends 229a, 229b the split fresh air enters the breathable zone 208 of the head enclosure 206 from two entry points, providing for bi-locational entry into the breathable zone 208.

Through the bi-directional entry of fresh air into the breathable zone 208 via the first channel 225a and the second channel 225b, the fresh air may circulate within breathable zone 208 with two air pathways. The two air pathways are depicted by direction 608 in the FIG. 6. The two air pathways aids in directing the air throughout the interior of the head enclosure 206, i.e., the breathable zone 208. This further aids in reducing dead pockets of stagnant air or a buildup of carbon dioxide. Following consumption of the fresh air, the waste carbon dioxide and used air may be directed out of the head enclosure 206 via the air outlet 226, following direction 610. Additionally, or alternatively, the waste carbon dioxide and used air may directed out of the head enclosure 206 via the skirt 212. For example, the waste carbon dioxide and used air may be directed through the space between the canine 102 and the skirt 212. Directing the waste carbon dioxide and used air out of hood 200 may further facilitate the reducing of dead pockets of stagnant air or the buildup of carbon dioxide.

### Exemplary Hardware

In FIG. 7, an exemplary hardware platform for certain embodiments of the present disclosure is depicted. For example, portions of the control system 500 may incorporate or include portions of the hardware platform as described with respect to FIG. 7. Computer 702 can be a desktop computer, a laptop computer, a server computer, a mobile device such as a smartphone or tablet, or any other form factor of general- or special-purpose computing device. For example, in embodiments, computer 702 may be client device 520 as described above with respect to FIG. 5.

Depicted with computer 702 are several components, for illustrative purposes. In some embodiments, certain components may be arranged differently or absent. Additional components may also be present. Included in computer 702 is system bus 704, whereby other components of computer 702 can communicate with each other. In certain embodiments, there may be multiple busses or components may communicate with each other directly. Connected to system bus 704 is central processing unit (CPU) 706. Also attached to system bus 704 are one or more random-access memory (RAM) modules 708. Also attached to system bus 704 is graphics card 710. In some embodiments, graphics card 710 may not be a physically separate card, but rather may be integrated into the motherboard or the CPU 706. In some embodiments, graphics card 710 has a separate graphics-processing unit (GPU) 712, which can be used for graphics processing or for general purpose computing (GPGPU). Also on graphics card 710 is GPU memory 714. Connected (directly or indirectly) to graphics card 710 is display 716 for user interaction. In some embodiments, no display is present, while in others it is integrated into computer 702. Similarly, peripherals such as keyboard 718 and mouse 720 are connected to system bus 704. Like display 716, these peripherals may be integrated into computer 702 or absent. Also connected to system bus 704 is local storage 722, which may be any form of computer-readable media and may be internally installed in computer 702 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through the fiber-optic cables. Examples of stored information include computer-usable instructions, data structures, program modules, and other data representations.

Finally, network interface card (NIC) 724 is also attached to system bus 704 and allows computer 702 to communicate over a network such as network 726. NIC 724 can be any form of network interface known in the art, such as Ethernet, ATM, fiber, Bluetooth, or Wi-Fi (i.e., the IEEE 802.11 family of standards). NIC 724 connects computer 702 to local network 726, which may also include one or more other computers, such as computer 728, and network storage, such as data store 730. Generally, a data store such as data store 730 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein such as backup or versioning. Data stores can be local to a single computer such as computer 728, accessible on a local network such as local network 726, or remotely accessible over Internet 732. Local network 726 is in turn connected to Internet 732, which connects many networks such as local network 726, remote network 734 or directly attached computers such as computer 736. In some embodiments, computer 702 can itself be directly connected to Internet 732.

### Alternative/Additional/Optional Features and Usage

Embodiments as described above and depicted in the figures illustrate exemplary embodiments of the hood 200, harness 300, the air supply unit 400, and the control system 500 of the canine respirator 100. However, in further embodiments, the design, configuration, and/or positioning of the components of canine respirator 100 may vary and may be adapted for intended applications.

For example, in some embodiments, the harness 300 may include one or more storage units, such as bags or pockets for the placement of one or more portions of the canine respirator 100 when the canine respirator 100 is not in use. The one or more storage units may be selectively placed on the harness 300, such that the weight of items or objects stored in the storage bags is supported by the body 106 of the canine 102. Optionally and/or additionally, the one or more storage bags may also provide a storage location for tools, equipment, or other items that may be used by the operator. For example, as described above, the canine 102 may be a military canine and the one or more storage units may be used to store additional ammunition, equipment, medical supplies, or other objects for a warzone.

In some embodiments, portion of head enclosure 206 may be constructed from a sturdy or hard material to protect the canine 102 from physical damage. For example, portions of head enclosure 206 may be constructed to act as a helmet to protect the canine 102 from debris or other physical objects. Non-limiting examples of solid materials that head enclosure 206 may be constructed from include, but are not limited to KEVLAR®, TWARON®, dense plastics, among other materials.

In some embodiments, head enclosure 206 may be adapted and configured for placement around the entirety of the canine's body 106. For example, in certain situations, the canine 102 and human operator may be deployed in an environment with a known risk of a chemical agent that causes harm upon contact with the skin. In addition to filtering the air from the environment, a need may exist to provide a barrier between the skin of the canine 102 and the environment. Accordingly, in some embodiments, head enclosure 206 may be adapted to fit around the head, legs, feet, body 106, and tail of the canine 102, providing a complete barrier between the canine 102 and the environment. Additionally, to aid an operator in donning embodiments of head enclosure 206 for placement around the entirety of the canine 102, head enclosure 206 may include zippers, buttons, snaps, or other fastening aids. For example, prior to donning on hood body 202, the operator may unzip a portion of the head enclosure 206 for easier placement around the body of the canine 102. Accordingly, after placement, the operator may zip and secure the head enclosure 206 to the canine 102, providing for additional coverage and protection.

In further embodiments, the hood 200 may vary in design or construction for certain deployment situations. For example, in embodiments, the head enclosure 206 may be adapted and configured for placement around less than entirety of the canine's body 106. For example, in certain situations or deployments, the head enclosure 206 may be designed as a muzzle, covering the mouth and nostrils of the canine. Such design may be particularly advantageous for a quick donning apparatus. Additionally, when the head enclosure 206 is designed as a muzzle, goggles or other eye coverings may be used to protect the canine's eyes 114. In even further embodiments, the hood 200 may be adapted and configured to provide physical protection to the canine 102. For example, portions of the head enclosure 206 may be strengthened or constructed from a hardened material, such that the head enclosure 206 may be helmet for the canine 102.

In some embodiments, canine respirator 100 may include one or more safety features or failsafe features in the event of part failure of canine respirator 100 or to adapt to events that unfold in real-time. For example, an environmental risk may occur on an active battlefield or in inclement weather. Such environmental factors or risks may increase the chance of damage to canine respirator 100, potentially causing the canine respirator 100 to stop operating or reduce effectiveness. To account for such complications or risks, canine respirator 100 may be adapted to perform even when one or more parts may be compromised.

For example, in addition to keeping fresh air within the interior of hood body 202, head enclosure 206 may likewise keep harmful air, particulates, particles, droplets, and/or vapor from entering the interior of hood body 202. Accordingly, in the event of damage, malfunctioning, or otherwise error of operation of the air supply unit 400, hood 200 may act as a passive gas mask. For example, in the event that fresh air cannot be directed into the hood 200, the canine 102 may rely on and utilize air trapped within the interior of hood 200 during the donning process. The canine 102 may utilize the trapped air until the air supply unit 400 can be fixed or until the canine 102 and operator escape the area.

In some embodiments, during an emergency situation, canine respirator 100 may be used with an external air source for delivering air to hood 200. For example, in the event that damage occurs to PAPR system, or other factor causing the air supply unit 400 stop delivering fresh air to the hood 200. As described in the preceding paragraph, the trapped air in the hood 200 may provide the canine 102 with a limited supply of air for consumption in the event that new, fresh air cannot be introduced into hood. However, during a prolonged environmental risk, the limited amount of air trapped within the interior of head enclosure 206 may not provide the canine 102 with an adequate air supply to survive a prolonged environmental risk. Accordingly, in some embodiments, an external air supply may be utilized by canine respirator 100 in an emergency event. If the external air supply is required, the operator may detach air tube 442 from the air supply unit 400 and connect air tube 442 to the external air supply.

In some embodiments, the external air supply may comprise any combination of bottled air, a tank, supply air from an auxiliary vehicle, a pump, an air blower, an air conditioning system, a rebreather, an auxiliary air purifying system, and an auxiliary air filtering system, as well as any other suitable external air supply and constituents thereof. In some embodiments, the external air supply may be a self-contained PAPR apparatus, such as a handheld PAPR device. The handheld PAPR may be stored in a container, bag, or storage unit on the harness 300 or on the operator. In further embodiments, the external air supply may be part of the PPE of the operator. For example, during an environmental risk, the operator may have their own PPE including an air supply unit or device. In the event of an emergency, equipment failure, or other reasons, the operator may connect the air tube 442 of the canine respirator 100 to the operator's air supply unit to deliver a burst of air to the hood 200. After delivering a burst of air to the hood 200, the operator may connect their own tube back to their own air supply to ensure the operator is provided with air. The operator may continue the cycle of delivering bursts of air to the canine 102 until the canine 102 and operator are rescued or reach a safe area.

Embodiments are contemplated in which canine respirator 100 may utilize an external air supply instead of, or in addition to, air supply unit 400. For example, an external air supply may connect to air tube 442 and directly supply fresh air to hood 200. In another example, an external air supply may connect to transport hose 432 such that main manifold 416 may control the flow of the fresh air from the external air supply and into hood 200.

In some embodiments, the canine respirator 100 may be further paired with additional technology to aid in operability of the canine respirator 100 and/or to provide additional functionality. For example, in some embodiments, the hood 200 may utilize heads up display (HUD) technology, which may be displayed on the viewing window 214. In embodiments, communications technology may be utilized, such as two-way communicators built into or paired with the main body 418. In embodiments, GPS technology may be utilized, such as a GPS tracker built into or paired with the main body 418. In embodiments, the hood 200, harness 300, and/or the air supply unit 400 may incorporate lighting systems and/or comprise attachment points for the securing of lights. In embodiments, the hood 200 and/or the harness 300 may utilize temperature controls for regulating the temperature of the canine 102. In embodiments, the hood 200 may utilize dehumidification and/or antifogging techniques. For example, the respective open second ends 229a, 229b may be positioned so that air delivered from the air supply unit 400 may be spread over the viewing window 214, providing an anti-fogging effect. In embodiments, hydration packs may be secured to the harness 300 and hydration tubing may be directed into the hood 200 to provide the canine 102 with water.

In some embodiments, the canine respirator 100 may utilize sensors for detecting any combination of internal pressure, breathing rate, heart rate, oxygen levels, biological threat agents, chemical threat agents, humidity, temperature, noise, position, movement, acceleration, and proximity, as well as any other suitable parameter or constituents thereof. For example, canine respirator 100 may include sensors to detect humidity such that hood 200 may utilize dehumidification techniques as discussed above. In another example, canine respirator 100 may utilize sensors for detecting oxygen levels such that the flowrate may be changed based on the detected oxygen levels. Further, in some embodiments, the canine respirator 100 may utilize any combination of audible, tactile, and visual indicators. For example, battery control 506 may comprise one or more visual indicators (e.g., one or more indicators 476, 478) for at least one battery 434 to indicate the battery life of the at least one battery 434. Further, battery control 506 may comprise an audible alarm to indicate the battery life of at least one battery 434 is running low.

Although the present disclosure has been described with reference to the embodiments illustrated in the attached drawing figures, it is noted that equivalents may be employed, and substitutions made herein without departing from the scope of the present disclosure as recited in the claims.

Having thus described various embodiments, what is claimed as new and desired to be protected by Letters Patent includes the following:

1. A respirator for donning on a canine having a body region and a head region, where the head region of the canine is at an anterior position on the canine, the respirator comprising:
a hood having a distal end positioned generally anterior to the canine, the hood comprising:
a head enclosure forming a breathable zone for receipt and encapsulation of filtered air when the respirator is donned on the canine;
a viewing window comprising a visually transparent material arranged at a location on the hood for allowing the canine to visually see through the viewing window when the respirator is donned on the canine;
an air entry port positioned proximate the distal end of the hood for receiving the filtered air; and
an intake air manifold fluidly coupled with the air entry port for receipt of the filtered air,
wherein the intake air manifold comprises at least one channel forming a pathway for the filtered air for delivery to a snout of the canine when the snout is positioned within the breathable zone; and
an air supply unit comprising:
at least one filter;
an air tube in fluid communication with the air entry port for delivering the filtered air to the hood; and
a mounting assembly,
wherein the air supply unit is attachable to a portion of the canine away from the body region of the canine via the mounting assembly.

2. The respirator of claim 1, wherein the intake air manifold includes a first outlet and a second outlet, wherein after placement of the hood around a head of the canine, each of the first outlet and the second outlet is located approximate to the snout of the canine.

3. The respirator of claim 1, wherein the mounting assembly is a collar comprising a first end and a second end, wherein each of the first end includes a first fastener and the second end includes a second fastener.

4. The respirator of claim 1, wherein the intake air manifold is disposed at the distal end of the hood for delivering the filtered air to the snout of the canine.

5. The respirator of claim 1, wherein the hood further comprises a sealing assembly.

6. The respirator of claim 5, wherein the sealing assembly is an elastic band for cinching a portion of the hood to a portion of the canine.

7. The respirator of claim 1, wherein the hood further comprises at least one sensor configured to detect carbon dioxide levels within the breathable zone.

8. A canine respirator comprising:
a hood comprising:
a viewing window;
an air intake port for receiving filtered air;
an intake air manifold for distributing the filtered air into one or more channels; and
at least one hood fastener;
an air supply unit for drawing in and filtering air from an environment comprising:
a first filter;
an air tube for delivering the filtered air to the hood; and
a mounting assembly,
wherein the air supply unit is attached to a portion of a canine away from a body of the canine via the mounting assembly; and
a harness for placement around the body of the canine, the harness comprising at least one harness fastener,
wherein the at least one hood fastener connects to the at least one harness fastener for connecting the hood to the harness,
wherein connecting of the hood to the harness prevents the canine from removing the air supply unit.

9. The canine respirator of claim 8, further comprising:
a head harness for placement around a head portion of the canine,
wherein the head harness comprises at least one fastener for coupling to at least one complimentary fastener of the hood.

10. The canine respirator of claim 8, wherein the first filter is attached to the mounting assembly and coupled to the air supply unit via a first transport tube.

11. The canine respirator of claim 10, further comprising a second filter attached to the mounting assembly and coupled to the air supply unit via a second transport tube.

12. The canine respirator of claim 11, further comprising a third filter attached to the mounting assembly and coupled to the air supply unit via a third transport tube.

13. The canine respirator of claim 12, further comprising a tubing system comprising at least a portion of the first transport tube, the second transport tube, and the third transport tube.

14. The canine respirator of claim 13, wherein the mounting assembly further comprises:
a first end comprising a first fastener; and
a second end comprising a second fastener configured to removably attach to the first fastener such that the mounting assembly is secured around a neck of the canine.

15. A method of providing filtered air to a canine, the method comprising steps of:
providing a canine respirator for use with a canine, the canine respirator comprising:
a hood comprising:
a viewing window;
an air entry port for receiving the filtered air;
an intake air manifold for distributing the filtered air into one or more channels; and
at least one hood fastener; and
an air supply unit comprising:
at least one filter for drawing in and filtering air from an environment;
an air tube for connecting to the air entry port for delivering the filtered air to the hood; and
a mounting assembly,
wherein the air supply unit is attached to a portion of the canine away from a body of the canine via the mounting assembly;
providing a harness for placement around the body of the canine, the harness comprising at least one harness fastener;
wherein the at least one hood fastener connects to the at least one harness fastener for connecting the hood to the harness,
wherein connecting of the hood to the harness prevents the canine from removing the air supply unit;
placing the hood on a head portion of the canine;
mounting the air supply unit on the canine at a position away from the body of the canine;
securing the harness on the body of the canine;
connecting a portion of the hood to a portion of the harness;
causing the air supply unit to draw in and filter the air from the environment; and
causing the air supply unit to deliver the air from the air supply unit to the hood.

16. The method of claim 15, wherein the air is drawn in from the environment at a rate of approximately 10 liters per minute to approximately 500 liters per minute.

17. The method of claim 15, wherein the harness further comprises at least one storage unit for storing at least a portion of the canine respirator when the canine respirator is not in use.

18. The method of claim 15, wherein the hood comprises a head portion for covering a portion of a head of the canine and a body portion for covering a portion of a body of the canine.

19. The method of claim 18, wherein the body portion includes one or more fasteners for coupling the hood to the harness and wherein the harness includes one or more fasteners for coupling with the one or more fasteners of the body portion.

20. The method of claim 15, wherein the harness comprises a first strap for wrapping around a body portion of the canine and a second strap for wrapping around a neck portion of the canine.
